(19) United States
(12) Patent Application Publication
(10) Pub. No.: US 2015/0156270 A1
(43) Pub. Date: Jun. 4, 2015

(54) CONTENT TRANSMISSION DEVICE

(71) Applicant: HITACHI MAXELL, LTD., Osaka (JP)

(72) Inventors: Hidetoshi Teraoka, Tokyo (JP); Chiyo Ohno, Tokyo (JP)

(21) Appl. No.: 14/407,742

(22) PCT Filed: Mar. 13, 2013
(86) PCT No.: PCT/JP2013/056898

§ 371 Date: Dec. 12, 2014

(30) Foreign Application Priority Data
Jun. 15, 2012 (JP) 2012-135312

(51) Int. Cl. H04L 29/08

(52) U.S. Cl. CPC H04L 67/28; H04L 67/16

(57) ABSTRACT

Devices used in mobile environments are making increasing demands for access to in-home content while commuting or traveling away from home. A content-receiving device that accesses an in-home content transmission device from outside the home: determines a method for establishing secure communication with a router in advance inside the home; executes a first authentication with the content transmission device and registration processing needed during access from outside the home; and registers information relating to the content-receiving device and out-of-home access information with the content transmission device. When utilizing the content-receiving device outside of the home to access the in-home content transmission device, the content transmission device sends content to the content-receiving device only when the content-receiving device is registered with the content transmission device, and only when second authentication is successful using the out-of-home access information therebetween.

### TECHNICAL FIELD

The present invention relates to technology for sending and receiving contents such as video and audio over a network, and relates in particular to a content transmission device ideal for sending copyright-protected contents.

### BACKGROUND ART

When sending contents among digital audio-video devices, copy-protect is performed by encrypting the contents on the content transmission device side, and sharing information for decoding the contents with the content receiving device side so that devices other than the content receiver device that is the transmission destination cannot correctly receive and decrypt the contents and in this way prevent unrestricted copying of the contents.

One example of this type of copy-protect method for use in digital audio-video devices is for example the method that is disclosed in Patent Document 1. The method disclosed in Patent Document 1 manages by classifying the contents in “Copy free”, “Copy free with EPN asserted”, “Copy one generation”, “No more copies”, and “Copy never” categories. The recording device records only the “Copy free”, “Copy free with EPN asserted”, and “Copy one generation” contents, and after recording the “Copy one generation” contents one time, treats the “Copy one generation” contents as “No more copies”, and by sending contents encryption processing on the sending side except for “copy-free” contents, prevents unrestricted copying of the contents.

Patent Document 1 and Patent Document 2 disclose a technology for use in content transmission along cable or wireless networks that determines whether the sending destination is an in-home network, in order to prevent the distribution of copyright-protected contents such broadcast programs that are recorded in the home, from being distributed to outside the home.

### PRIOR ART DOCUMENT

### Patent Document

Patent Document 1: Japanese Patent Application Laid-Open No. 2005-269288
Patent Document 2: Japanese Patent Application Laid-Open No. 2007-36351

### SUMMARY OF THE INVENTION

### Problem to be Solved by the Invention

Users who own device capable of usage in a mobile environment utilizing portable type information terminals such as notebook PCs and portable terminals are requesting access to in-home contents while at a travel destination or while commuting on a train by using these devices. However, when sending copyright-protected contents over a cable or a wireless network, the technology of the related art includes a built-in function that checks whether the sending side and receiving side devices are within the same home, and only sends the contents when the devices are within the same home. The accessing of copyright-protected contents from an out-of-home destination) was therefore impossible.

### Means for Solving the Problem

In order to resolve the aforementioned problems, a configuration is utilized as described in the range of the claims.

### Effect of the Invention

The invention renders the effect that the user is capable of viewing in-home contents from outside the home by largely the same operating methods as within the home and without exceeding the scope allowed for individual usage and so the convenience to the user is improved.

The above described issues, structure, and effects will become readily apparent from the subsequent description of the embodiments.

### BRIEF DESCRIPTION OF THE DRAWINGS

FIG. 1 is a block diagram showing a configuration example of the system;

FIG. 2 is a block diagram showing a configuration example of the system;

FIG. 3 is a block diagram showing a configuration example of the STB having storage playback function;

FIG. 4 is a block diagram showing a configuration example of the TV having storage playback function;

FIG. 5 is a block diagram showing a configuration example of the mobile device;

FIG. 6 is a block diagram showing a configuration example of the router for remote access;

FIG. 7 is a drawing showing a configuration example of the software of the STB having storage playback function;

FIG. 8 is a drawing showing a configuration example of the software of the mobile device;

FIG. 9 is a drawing showing a configuration example of the software for the router for remote access;

FIG. 10 is a drawing showing an example of the device information that is managed by the STB having storage playback function;

FIG. 11 is a drawing showing an example of the device information that is managed by the mobile device;

FIG. 12 is a drawing showing an example of the content transmission sequence within the home;

FIG. 13 is a drawing showing an example of the device authentication processing sequence within the home;

FIG. 14 is a drawing showing an example of the device information that is managed by the router for remote access;

FIG. 15 is a drawing showing an example of the setup processing sequence for the mobile device within the home:

FIG. 16 is a drawing showing an example of the device registration processing sequence for the mobile device within the home;

FIG. 17 is a drawing showing an example of the screen that the mobile device displays;

FIG. 18 is a drawing showing an example of the screen that the mobile device displays;

FIG. 19 is a drawing showing an example of the connection processing sequence from outside the home to within the home;

FIG. 20 is a drawing showing an example of the content transmission sequence from within the home to outside the home;

FIG. 21 is a drawing showing an example of the device authentication processing sequence from outside the home to within the home;

FIG. 22 is a drawing showing a configuration example of the transmission data that the STB having storage playback function sends;

FIG. 23 is a drawing showing an example of the screen that the mobile device displays;

FIG. 24 is a drawing showing a configuration example of the software for the STB having storage playback function;

FIG. 25 is a drawing showing an example of the remote access management information that the STB having storage playback function manages;

FIG. 26 is a drawing showing an example of the setup processing sequence of the remote accessing within the home; and

FIG. 27 is a drawing showing an example of the screen that the STB having storage playback function displays.

### MODES FOR CARRYING OUT THE INVENTION

The embodiments for implementing the present invention are described next while referring to the drawings. In the drawings for the embodiment, the same reference signs and reference numerals express identical sections or equivalent sections. Moreover, the present invention is not limited to the examples of the drawings.

### First Embodiment

In the present embodiment, a method is described for remotely accessing the in-home device from the out-of-home device, and remotely viewing the contents that are stored within the in-home device.

### <System Configuration>

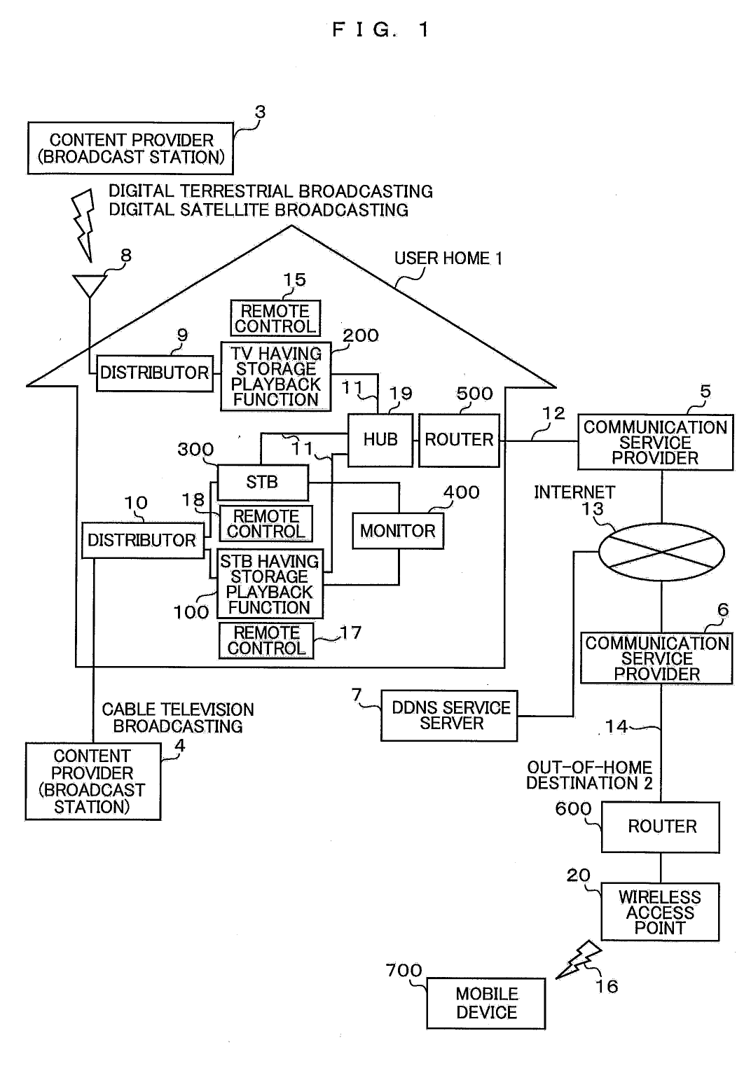

FIG. 1 is a block diagram showing a configuration example of the system of the present embodiment.

Reference numeral 1 denotes the user home receiving the broadcast, 2 denotes the out-of-home destination (such as a hotel or company, etc.) that cannot directly access the user home 1 network; 3 and 4 denote the broadcast station serving as the source providing the content; 5 and 6 denote the communication service provider; 7 denotes the server providing the DDNS (Dynamic Domain Name System) service; 12 and 14 donates the access networks for providing the communication service providers 5 and 6; 13 denotes the internet joining the operation points such as the access networks 12 and 14.

In the present embodiment, the broadcast station 3 and the broadcast station 4 transmit broadcast (programs) by different broadcast methods. In the examples that are used here, the broadcast station 3 sends a digital terrestrial broadcast using ground waves, and the broadcast station 4 sends digital cable television (CATV) broadcasts by way of transmission lines. The broadcast methods for the broadcast station 3 and the broadcast station 4 may be respectively different methods, and may be a combination such as CATV broadcasts and BS digital broadcasts that are sent by satellite radio waves.

In the user home 1, the reference numeral 8 denotes the broadcast receiving antenna, the reference numerals 9 and 10 denote the distributors, 500 denotes the router, 19 is the hub, 200 denotes the TV having storage playback function including a function to receive the terrestrial digital broadcast that is sent by the broadcast station 3 and record and play it; 300 denotes the STB (Set Top Box) that receives the CATV broadcast that the broadcast station 4 sends; 100 denotes the STB having storage playback function to receive and record and play the CATV broadcast sent by the broadcast station 4; 400 denote the monitor that outputs video and audio data that is played by the STB300 and the STB having storage playback function 100.

The broadcast receiving antenna 8 receives the digital terrestrial broadcast that the broadcast station 3 is sending, and the received digital broadcast is distributed by way of the distributor 9 to the TV having storage playback function 200 that is capable of receiving the terrestrial digital broadcast.

The CATV broadcast that is sent by the broadcast station 4 is sent to the user home 1 by way of a dedicated transmission line, and is distributed to the STB having storage playback function 100 and the STB 300 capable of receiving CATV broadcasts by way of the distributer 10. The CATV broadcast that the STB300 and the STB having storage playback function 100 receive, and the content that is played by the STB having storage playback function 100 is output and is displayed on the monitor 400.

The user for the user home 1 can use the respective remote controls 17, 15, 18 to operate the STB having storage playback function 100, the TV having storage playback function 200, and the STB 300.

The STB having storage playback function 100, the TV having storage playback function 200, and the STB 300 for the user home 1 can be mutually coupled by way of the hub 19 to the cable LAN (Local Area Network) 11; to configure a home network for the user home 1 from these devices (the STB having storage playback function 100, the TV having storage playback function 200, and the STB 300) that are coupled to the hub 19. Each device on the LAN11 is coupled by way of the router 500 to the access network 12 and the Internet 13 that are provided by the communication provider 5.

The mobile device 700 for the out-of-home destination 2 is capable of communicating by way of the wireless LAN 16 and the wireless access point 20 that are provided for a fee or free of charge; and can couple to the Internet 13 and the access network 14 provided by the communication service provider 6 by way of the router 600.

Each device within the user home 1 in FIG. 1 is here coupled to the router 500 by way of the hub 19 by the cable LAN11 however the hub 19 and the router 500 may be integrated into one unit. The hub 19 and/or the router 500 may even be integrated into a single unit with the wireless access point not shown in the drawing, and also capable of performing communication among each device within the user home 1 by utilizing the wireless LAN instead of the cable LAN. In this case, communication by the wireless LAN is possible by a wireless function within each device in the user home 1 or by mounting a cable LAN-wireless LAN conversion adapter in each device.

In the present embodiment, the router 500 is integrated into one unit with the wireless access point and can communication with each device within the user home 1 by way of the router 500, when using the mobile device 700 that is brought from the out-of-home destination 2 in FIG. 1, within the user home 1.

The cable LAN 11, the access networks 12 and 14, the Internet 13, and the wireless LAN 16 within the user home 1, use a standard IP (Internet Protocol) as the network protocol, and use TCP (Transmission Control Protocol) and UDP (User Datagram Protocol) as the upper level transport protocol. An upper level application protocol such as RTP (Real-time Transport Protocol) or HTTP (Hype Text Transfer Protocol), and FTP (File Transfer Protocol) are used to transfer each type of information and content. The IP is available in different versions which are IPv4 and IPv6 but the present embodiment is not limited to either of these versions.

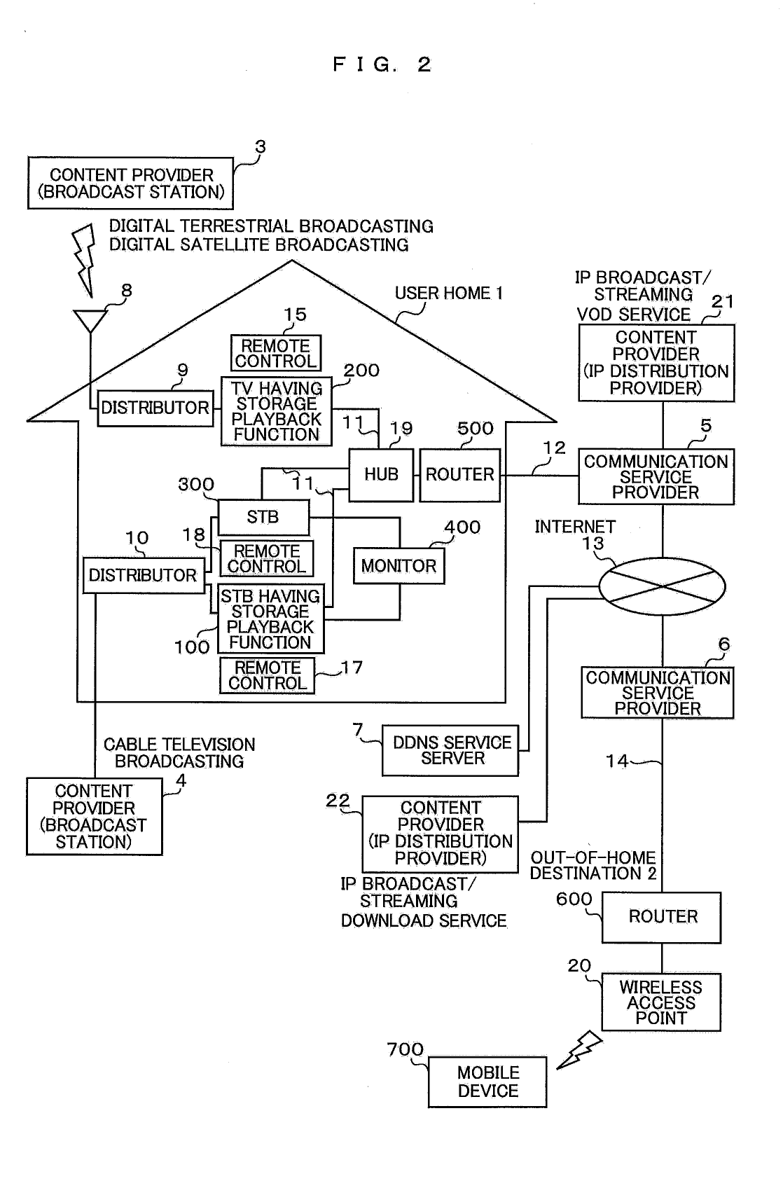

FIG. 2 is another configuration example of the present embodiment.

The reference numerals 21 and 22 are IP distribution providers that serve as source for providing the content, and provide VOD (Video on Demand) services and IP broadcasts, and content downloading services over a network.

The IP distribution provider 21 provides each type of service along the access network 12 that is provided by the communication service provider 5 under contract with the user home 1. The STB having storage playback function 100, the TV having storage playback function 200, and the STB 300 are capable of utilizing the above described VOD service and content downloading service by way of the router 500 and hub 19 via the access network 12.

The IP distribution provider 22 provides each type of service over the Internet 13. The STB having storage playback function 100, the TV having storage playback function 200, and the STB 300 are capable of receiving the above described VOD service and content downloading service by way of the router 500 and the hub 19 via the Internet 13 and the access network 12. All other structural elements are the same as in FIG. 1.

### <Structural Block for Each Device>

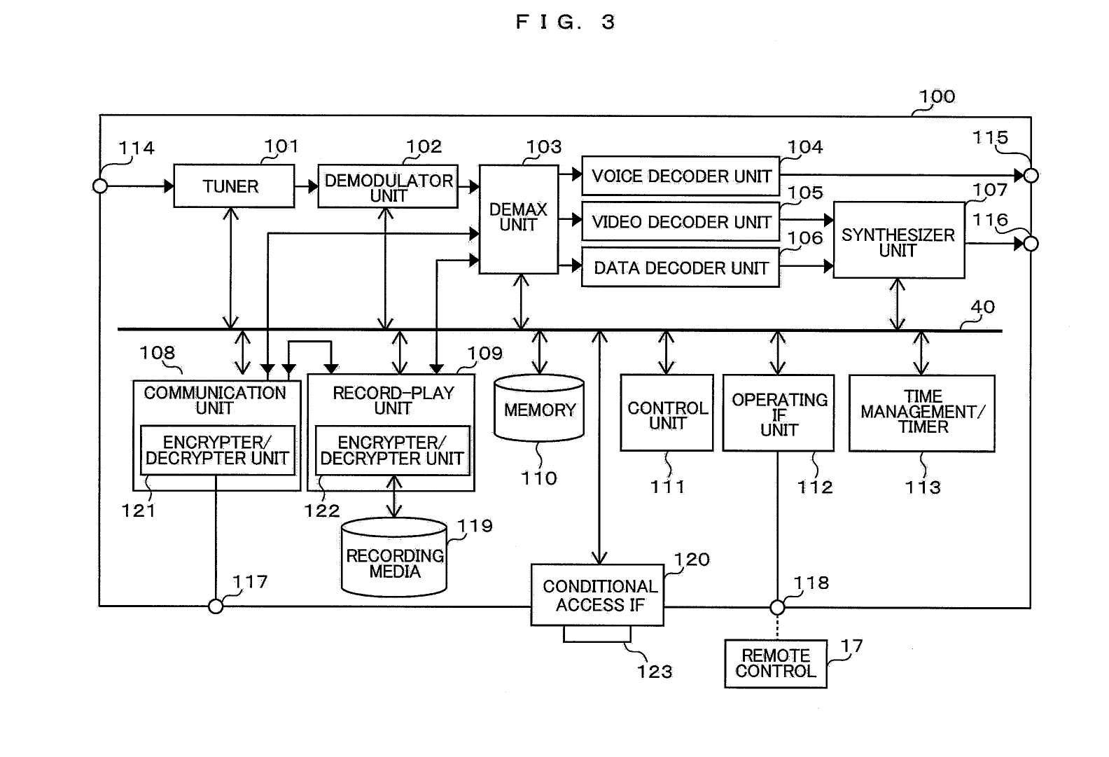

FIG. 3 is a block diagram showing a configuration example of the STB having storage playback function 100.

The STB having storage playback function 100 is comprised of a tuner 101, a demodulator unit 102, a demax unit 103, an audio decoder unit 104, a video decoder unit 105, a data decoder unit 106, a synthesizer unit 107, a communication unit 108, a record-play unit 109, a recording media 119, a conditional access IF 120, a control unit 111, a memory 110, an operating IF unit 112, a time management timer unit 113, an antenna coupling terminal 114, a digital audio signal output terminal 115, a digital video signal output terminal 116, a network terminal 117, and an operating signal receiver unit 118.

The CATV broadcast is input from the antenna coupling terminal 114 to the tuner 101. The tuner 101 extracts the channel frequency band of the channel that must be received and outputs it as a baseband signal by quadrature demodulation to the demodulator unit 102.

The demodulator unit 102 performs synchronous demodulation of the baseband signal using for example 8PSK (Phase Shift Keying), implements error correction for example using Viterbi decoding or RS (Reed-Solomon) decoding and outputs the digital broadcast signal as a decoded signal to the demax unit 103. Here, the case where the digital broadcast signal is compression-encoded by the MPEG (Moving Picture Experts Group) method and handled as multiplexed MPEG2-TS by the TS (Transport Stream) method is described.

The demax unit 103 isolates and extracts signal used in stages subsequent to the multiplexed MPEG-2TS. The demax unit 103 then acquires key information that is retained in the restriction receiving info storage unit 123 by way of the conditional access IF (interface) 120, and eliminates the scrambling that is applied to the MPEG2-TS for copyright protection by using this information, and outputs data such as data broadcasts or ES (Elementary Stream) or PES (Packetized Elementary Stream) which is the signal stream of the video signals or audio signals or subtitles that utilize this information.

The audio decoder unit 104 decodes the PES or ES which are audio signals that are isolated and extracted by the demax unit 103 and outputs them to the digital audio signal output terminal 115.

The video decoder unit 105 decodes the PES or ES which are video signals that are isolated and extracted by the demax unit 103 and outputs them to the synthesizer unit 107.

The data decoder unit 106 decodes the data broadcast signal or the subtitles that are isolated and extracted by the demax unit 103 and outputs them to the synthesizer unit 107.

The synthesizer unit 107 synthesizes the signals input from the data decoder unit 106 and video decoder unit 105 to configure the display screen and outputs them to the digital video signal output terminal 116.

The communication unit 108 contains an encrypter/decrypter unit 121, and sends and receives data or content with other devices on the LAN 11 coupled by the hub 19 via the network terminal 117 or with an out-of-home “out-of-home” server via the router 500. The encrypter/decrypter unit 121 encrypts data and content for sending such as out-of-home servers or other devices on the LAN 11 within the user home 1. The encrypter/decrypter unit 121 also decrypts content and data that is received from an out-of-home server or another device on the LAN11 within the user home 1.

The record-play unit 109 contains an encrypter/decrypter unit 122, and manages the recording processing for writing the contents acquired by way of a network and the contents such as broadcast programs that are received onto the recording media 119; manages the playback processing of the recorded contents loaded and output from the recording media 119, and manages the deletion processing of the recorded contents. When recording the content onto the recording media 119, the encrypter/decrypter unit 122 applies an encryption processing that is suited to the recorded contents. When loading the content from the recording media 119, the encrypter/decrypter unit 122 decrypts the encryption applied during recording and outputs the content. The key that is utilized in encrypting and decrypting is generated in conformance with a specified algorithm and is retained in the memory 110 or in the recording media 119.

The recording media 119 includes either or both a recording media that is not removable such as a hard disk, or a recording media that is removable such as an optical disk, removable hard disk, or memory card. The recording media 119 may also include several types of recording media such as hard disks, optical disks, and memory cards.

The control unit 111 executes processing for the OS (Operating System) and applications, and enables operation of the STB having storage playback function 100.

The memory 110 is comprised of a volatile memory and a non-volatile memory. The non-volatile memory stores software and fixed data for operating the OS and applications such as the STB having storage playback function 100. The volatile memory stores data required for software operation.

The operating IF (interface) unit 112 receives and processes signals input from the remote control 17 in the operating signal receiver unit 118. Even a mouse, keyboard, or touch panel may serve as the remote control 17.

The operating signal receiver unit 118 may receive signals input from the remote control 17 without wires or cable by utilizing infrared rays for example, and may even receive signals input from the remote control 17 by coupling to the remote control 17 via coupling terminals.

The time management/timer 113 monitors the time by utilizing time information that is contained in the broadcast signal input by way of the tuner 101 or time information that is provided by a NTP (Network Time Protocol) server present in the access network 12 or the Internet 13. The NTP is a protocol for synchronizing the device clocks to the correct time among devices coupled over a network. The time management/timer 113 contains a timer setting and operation function for controlling the time-out of each type of operation and for setting the scheduling menu or the viewing schedule.

The conditional access IF (Interface) 120 is an interface for coupling the restriction receiving info storage unit 123. The restriction receiving info storage unit 123 retains key information for unlocking the applied scramble.

The system bus 40 is a data bus coupling to all structural elements of the STB having storage playback function 100. The system bus 40 is used for communicating data signals and control signals between each of the structural elements.

The digital audio signal output terminal 115 and the digital video signal output terminal 116 are output terminals for respectively outputting non-compressed digital audio signal and the digital video signal for example to external television in order to view content such as a recorded broadcast program or a broadcast program that is received by the STB having storage playback function 100. The digital audio signal output terminal 115 and the digital video signal output terminal 116 can be physically separated connectors, or can be mounted as one connector by utilizing a connector including plural output terminals. Control signal output terminals can also be assigned to the connector, and the control signal output terminals may output display device control signals in order to control the externally coupled display device such as a display.

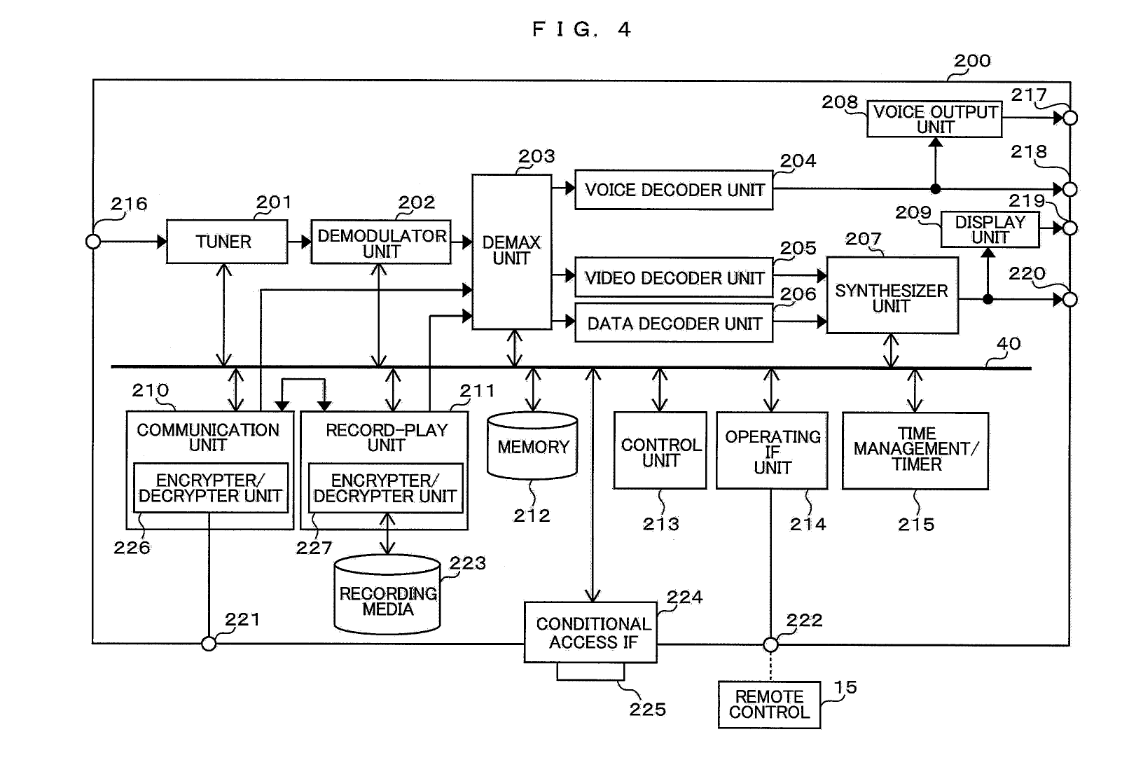

FIG. 4 is a block diagram showing a configuration example of the TV having storage playback function 200.

The TV having storage playback function 200 is comprised of a tuner 201, a demodulator unit 202, a demax unit 203, a voice decoder unit 204, a video decoder unit 205, a data decoder unit 206, a synthesizer unit 207, an audio output unit 208, a display unit 209, a communication unit 210, a record-play unit 211, a recording media 223, a conditional access IF224, a control unit 213, a memory 212, an operating IF unit 214, a time management/timer 215, an antenna coupling terminal 216, an audio signal input terminal 217, a digital audio signal output terminal 218, a video signal input terminal 219, a digital video signal output terminal 220, a network terminal 221, and an operating signal receiver unit 222.

The digital terrestrial broadcast is input from the antenna coupling terminal 216 to the tuner 201.

The audio output unit 208 decodes the non-compressed digital audio signal output from the audio decoder unit 204 and plays it on a speaker. The non-compressed digital audio signal input from the audio signal input terminal 217 may also be decoded and played on a speaker or the analog audio signal may be played on a speaker. The communication unit 210 contains an encrypter/decrypter unit 226, and the record-play unit 211 contains a record-play unit 227.

The display unit 209 decodes and displays the non-compressed digital video signal output from the synthesizer unit 207 on a monitor. The display unit 209 decodes and displays the non-compressed digital video signal input from the video signal input terminal 219 on a monitor, or display the analog video signal on a monitor.

Sections other than described above include the same functions as in FIG. 3.

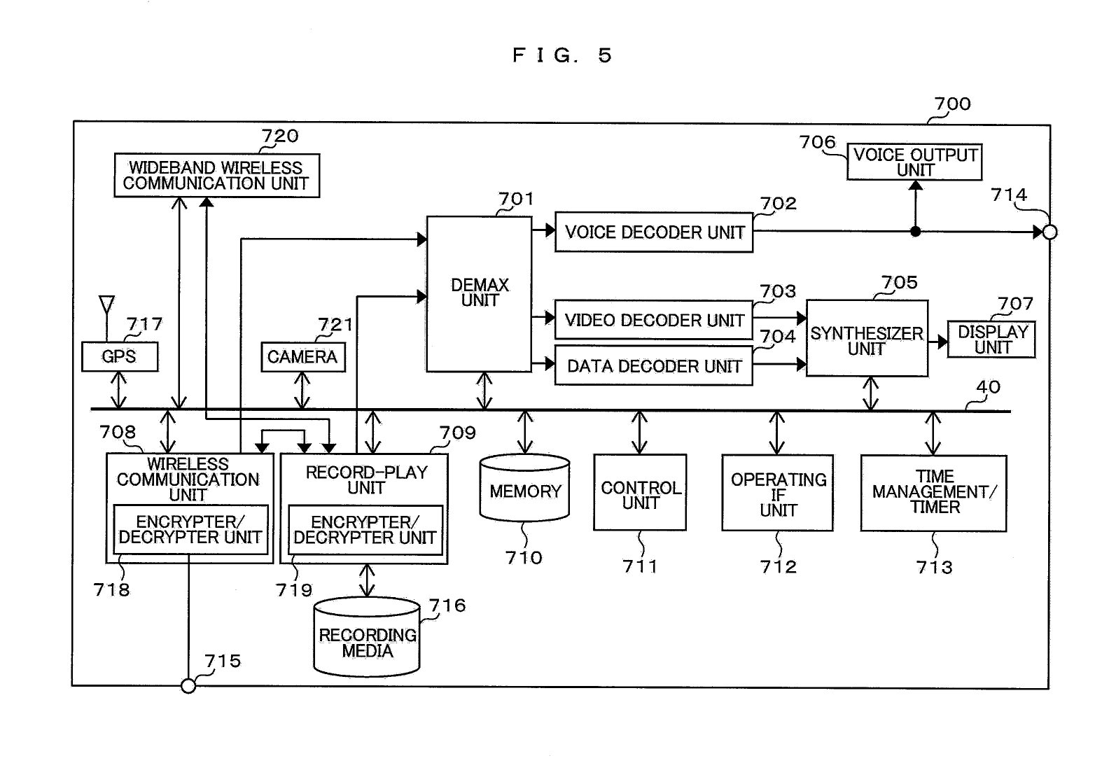

FIG. 5 is a block diagram showing a configuration example of the mobile device 700.

The mobile device 700 is comprised of a demax unit 701, a voice decoder unit 702, a video decoder unit 703, a data decoder unit 704, a synthesizer unit 705, a voice output unit 706, a display unit 707, a wireless communication unit 708, a wideband wireless communication unit 720, a record-play unit 709, a recording media 716, a control unit 711, a memory 710, an operating IF unit 712, a time management/timer 713, a GPS (Global Positioning System) 717, a camera 721, a digital audio signal output terminal 714, and a wireless network terminal 715. The wireless communication unit 708 contains an encrypter/decrypter unit 718, and the record-play unit 709 contains an encrypter/decrypter unit 719.

The wideband wireless communication unit 720 is a wireless communication section for performing telephone and packet communication such as 3G or LTE (Long Term Evolution), WiMAX (Worldwide Interoperability for Microwave Access), etc.

The operating IF unit 712 receives and processes the input signals from the touch panel. The GPS 717 receives a signal from the GPS satellite and acquires the current position.

The camera 721 captures a photograph or QR code (Quick Response registered trademark). The control unit 711 links the photograph data that is captured by the camera 721 to the information in the GPS717, stores it in the recording media 716 by way of the record-play unit 709 or stores it directly in the memory 710.

Sections other than described above include the same functions as in FIG. 3 and FIG. 4.

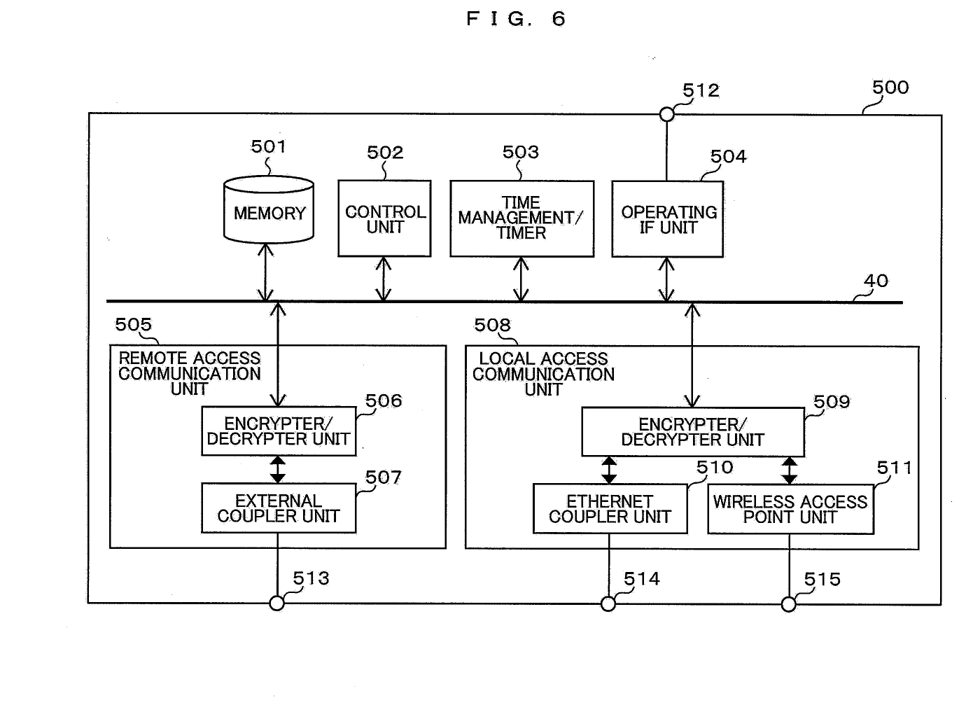

FIG. 6 is a block diagram showing a configuration example of the router 500.

The router 500 is comprised of a control unit 502, a memory 501, a time management/timer 503, an operating IF unit 504, a local access communication unit 508, a remote access communication unit 505, an operating signal input unit 512, a cable network coupling terminal 514, a wireless network communication terminal 515, and an out-of-home network coupling terminal 513.

The operating IF unit 504 receives and processes the input signal from the operating signal input unit 512 per the operating button.

The local access communication unit 508 contains a Ethernet (registered trademark) coupler unit 510, a wireless access point unit 511, an encrypter/decrypter unit 509, and sends and receives data and contents between other devices within the user home 1.

The Ethernet coupler unit 510 sends data and contents over the cable LAN by way of the cable network coupling terminal 514 or receives data and contents by way of cable LAN from other devices within the user home 1.

The wireless access point unit 511 sends data and contents over the wireless LAN by way of the wireless network communication terminal 515 or sends data and contents by way of a wireless LAN from other devices within the user home 1.

The encrypter/decrypter unit 509 encrypts data and contents for output to the Ethernet coupler unit 510 and the wireless access point unit 511 and decrypts data and contents output from the Ethernet coupling unit 510 and the wireless access point unit 511.

The remote access communication unit 505 contains an external coupler unit 507, and an encrypter/decrypter unit 506, and sends and receives data and content with the distribution server for the (IP) content provider 21 or the (IP) content provider 22 that are outside the user home 1 or the mobile device 700 that is brought to the out-of-home destination 2.

The external coupler unit 507 sends data and content over the network 12 by way of the out-of-home coupling terminal 513, and receives data and content by way of the access network 12.

Sections other than described above include the same functions as in FIG. 3 and FIG. 4.

### <Software Configuration for Each Device>

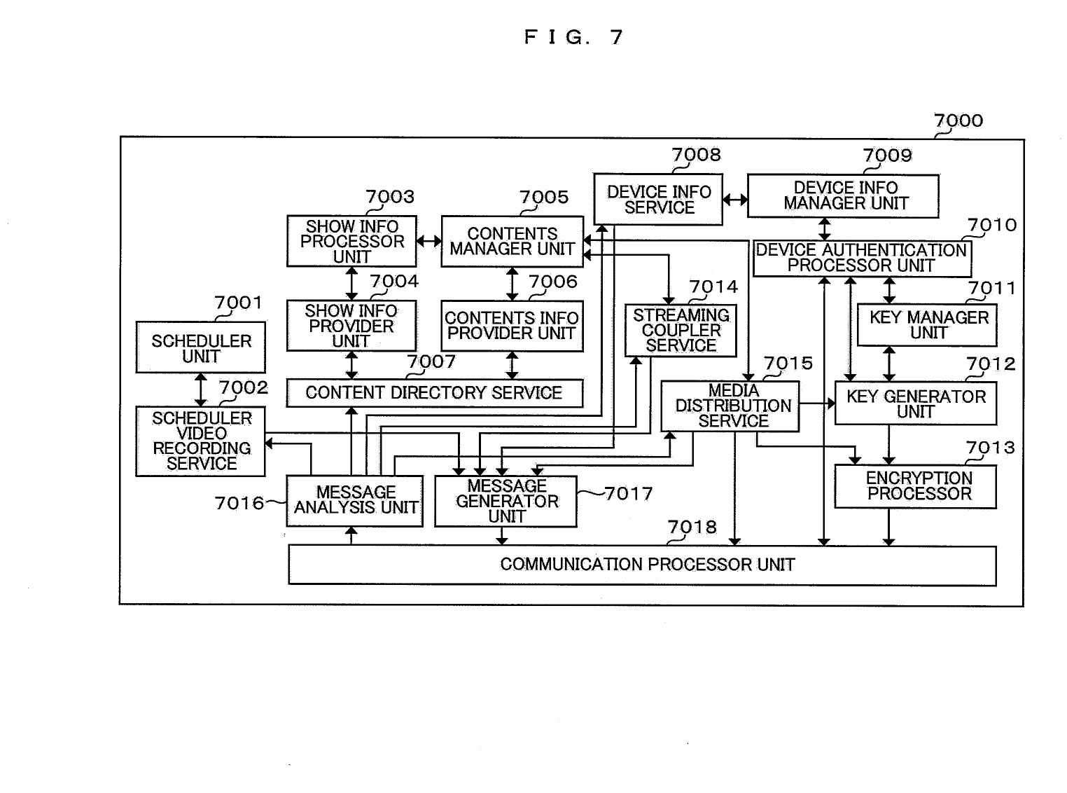

FIG. 7 is a drawing showing a configuration example of the software of the STB having storage playback function 100 shown in FIG. 3.

The control software 7000 for implementing the functions of the STB having storage playback function 100 is operated on the memory 110 and executed by the control unit 111 in the STB having storage playback function 100. FIG. 7 describes the software 7000 divided into functional blocks, and each block can be divided or unified. Moreover the control software 7000 need not be implemented on one program and can be implemented even by a combination of two or more programs.

The control software 7000 is comprised of a scheduler unit 7001, a scheduler video recording service 7002, a show info processor unit 7003, a show info provider unit 7004, a contents manager unit 7005, a contents info provider unit 7006, a content directory service 7007, a device info service 7008, a device info manager unit 7009, a device authentication processor unit 7010, a key manager unit 7011, a key generator unit 7012, a encryption processor 7013, a streaming coupler service 7014, a media distribution service 7015, a message analysis unit 7016, a message generator unit 7017, a communication processor unit 7018, and a show (program) table generator unit 7019.

The scheduler unit 7001 accepts scheduling for viewing and recording set for example by the user operating the electronic program table or scheduling for recording specified from the scheduler video recording service 7002, and stores and manages it in the memory 110 or the recording media 119. The scheduler unit 7001 performs the setting process when executing the scheduling. The scheduler unit 7001 for example monitors the start time of a program that is scheduled by using the time management timer 113 and appropriately sets the channels for receiving at the tuner 101. If scheduling recording, the scheduler unit 7001 sets so that the stream containing content such as the broadcast program is output from the demax unit 103 to the record-play unit 109.

The show table generator unit 7019 show (or program) searches the show info processor unit 7003 and utilizes the program information that is acquired there to generate an electronic program table for the user to view information on the program that is scheduled for broadcast; select and tune in the desired program, or provide a user interface capable of scheduling viewing or recording of the desired program.

The show info processor unit 7003 acquires program information such as broadcast schedules and program titles from the PES or ES containing information on broadcast programs that are isolated and extracted by the demax unit 103, configures the program information table and records it in the memory 110 or the recording media 119. The show info processor unit 7003 acquires program information for all broadcast stations capable of being received by the STB having storage playback function 100. When new program information is acquired or there is a change in the acquired program information, the program information table is then rewritten each time. The program information is inserted for example in program specific information (PSI) for MPEG-TS or program service information (SI).

The show info provider unit 7004 searches the show info processor unit 7003 and provides list information for planned channels, program list information for specified channels, or information on each program to the content directory service 7007 in accordance with request from the content directory service 7007 described later on.

When recording contents in the recording media 119, the contents manager unit 7005 generates (may even utilize database functions) content information for those contents, and records them in the memory 110 or the recording media 119. When contents for recording are a broadcast program, that content information is acquired from the show info processor unit 7003, and when the contents are acquired by way of a network, that content information is acquired from the transmission source of the content. The contents manager unit 7005 executes the linking of content with corresponding content information, updating the content information when deleting or moving the contents, monitoring the number of copies for contents that are allowed only a certain number of copying, monitoring the content status (stopped, recording-in-progress, playback-in-progress, etc.), or monitoring the remote access limit (permit/prohibit) that is added beforehand (or is specified) to the contents or channel.

The contents info provider unit 7006 searches the contents manager unit 7005 and provides list information for recording programs or detailed information on designated recording programs in compliance with request from the contents directory service 7007 that is described later on.

The device authentication processor unit 7010 authenticates whether or not devices are mutually authorized in conformance with designated authentication protocols among other devices in order to send and receive contents subject to copyright protection by way of cable or wireless network, and shares a key for use in encrypting and decrypting of data or contents with the other devices only when the authentication is a success.

The device info manager unit 7009 acquires from the device authentication processor unit 7010, information (unique information and address information, etc.) relating to devices coupled over a network where authentication by the device authentication processor unit 7010 is a success and manages tasks such as registration, updating, and deleting, etc. This information is retained in the memory 110.

When authentication by the device authentication processor unit 7010 succeeds, the key manager unit 7011 acquires the key shared among the devices coupled over a network and attachment information relating to the key (information relating to the label and data for management by the device info manager unit 7009) from the device authentication processor unit 7010, and manages tasks such as registration, updating, and deleting, etc. This information is retained in the memory 110.

The key generator unit 7012 acquires keys for management by the key manager unit 7011 and attachment information when sending data and contents between devices where authentication by the device authentication processor unit 7010 is a success, and generates an encryption key in conformation with a specified algorithm by utilizing them. The encryption key is also periodically updated (or rewritten) in compliance with the specified protocol.

When sending data, or content that is stored in the recording media 119, and a broadcast program that is received by way of the tuner 101 to devices coupled over a network; the encryption processor 7013 sets an encryption key that is acquired from the key generator unit 7012 into the encrypter/decrypter unit 121 within the communications unit 108 of FIG. 3 and performs encrypting of the data or contents. The encryption processor 7013 acquires a new encryption key each time the encryption key is updated in the key generator unit 7012 and changes the encryption key. The encrypted data or contents are sent to other devices by way of the communication processor unit 7018 by an appropriate communication protocol. Here, the contents that are stored in the recording media 119 are encoded during storage by the record-play unit 109. In this case, after the encrypter/decrypter unit 122 within the record-play unit 109 decodes the encrypted contents loaded from the recording media 119, the encryption processor 7013 performs the above described encrypting and the encrypted contents are sent to another device.

The communication processor unit 7018 performs analysis of the communication protocol and flow control of the communication data. The communication processor unit 7018 also processes the communication data according to the communication protocol when sending and receiving content and control messages among other devices coupled over the network. The communication data is sent and received by way of the network coupling terminal 117 and the communication unit 108 in FIG. 3.

The message analysis unit 7016 analyzes messages such as control requests sent and received among devices on the network and which are generated according to a specified format, and allots the requested control to a service for processing. Here, the service is a function capable of utilizing remote operation by way of a network and that is provided by a device to another device. In FIG. 7, the scheduler video recording service 7002, the content directory service 7007, a device info service 7008, the streaming coupler service 7014, a media distribution service 7015 are equivalent to such a service.

The message generator unit 7017 generates messages according to a specified format that is utilized between devices over the network which are a response to control requests output from a service and control requests for other devices. The messages that the message generator unit 7017 generates are sent by way of the communication processor unit 7018 to other devices by an appropriate protocol.

The scheduler video recording service 7002 provides list information for scheduled recording or settings for registration or deletion of recording scheduled over a network.

The content directory service 7007 provides metadata information such as the title and genre for all contents that the STB having storage playback function 100 is capable of providing to other devices. The content directory service 7007 respectively collects metadata information regarding contents that are recorded in the recording media 119 from the contents info provider unit 7006; and metadata information regarding information for the broadcast program from the show info provider unit 7004.

The device info service 7008 provides to other devices information such as all or a portion of device information acquired from the device info manager unit 7009 or device description information for the device itself, and detailed service information (including its own URL (Uniform Resource Locator) information, etc.) describing details of the service the device provides. Moreover, the device info service 7008 gives notification over a home network when it is coupling to a network or detaching from a network, and replies to device searches from other devices.

The device description information here includes information such as device information and service information lists.

The device information is basic information that describes the devices and so includes information such as the device type, device name, manufacturer name, model name, serial number, network ID (an ID for uniquely identifying a device on a network and that is stored in the memory 710), version, and icon information. The device type is information that shows the function the device provides to the network. The device type for example is defined as a MediaServer for devices including a function for content distribution such as of information on video, audio, and electronic program table; and as a MediaRenderer for devices including a function for receiving contents over a network and for playback.

The service information list is list information for the service that is provided to other devices according to the mounted device type. Each service includes a service type (item showing the function of the service such as a content directory, etc.); a service ID (ID for unique identifying the service); a service description URL (access destination for acquiring detailed information on the service regarding details for the (control method for utilizing the control that the service provides {action}); a control URL (transmit destination for the action command for performing control using the service); an event URL (registration destination to send the event distribution registration for receiving notification when an event occurs in the service), etc.

The service detail information contains information such as an action list and service status table. The action list is a list containing information for one or more actions (action name, argument information, etc.) An action is a description for a control method for utilizing the control that the service provides. The service status table is a table including one or more status variable information (setting range, default value, and data type of argument for use in the action, etc.)

The streaming coupler service 7014 provides information for the type of transfer protocol and content, and the data format matching the STB having storage playback function 100. The transfer protocol is items such as HTTP and RTP (Real-time Transport Protocol). The content type shows video, audio, and images, and the data format shows encoding methods for contents such as MPEG (Moving Picture Experts Group) or MP3 (MPEG Audio Layer-3), H.264, etc.

The media distribution service 7015 is a content provision unit for providing a service to send the designated contents over a home network (namely a network within the user home 1) or send to other devices by way of the access network 12 or the Internet 13. The media distribution service 7015 outputs to the communication processor unit 7018, content such as broadcast programs that the STB having storage playback function 100 receives, or broadcast programs that are recorded on the recording media 119. The media distribution service 7015 also provides an interface for controlling distribution of content such as by starting, stopping, pausing, skipping, or starting distribution by way of a network.

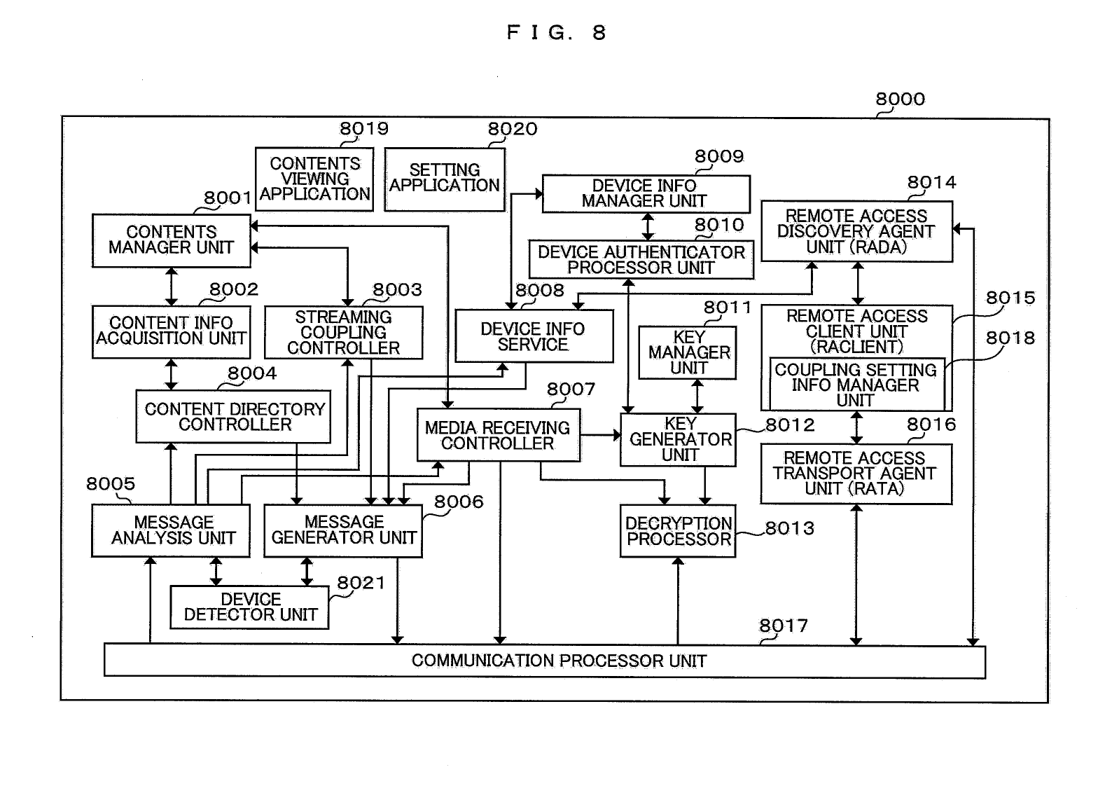

FIG. 8 is a drawing showing a configuration example of the software for the mobile device 700 shown in FIG. 5.

The control software 8000 for implementing the functions of the mobile device 700 is operated on the memory 710 and executed by the control unit 711 in the mobile device 700. FIG. 8 describes the software 8000 divided into functional blocks, and each block can be divided or unified. Moreover the control software 8000 need not be implemented on one program and can be implemented even by a combination of 2 or more programs.

The control software 8000 is comprised of a contents manager unit 8001, contents info acquisition unit 8002, a message analysis unit 8005, a message generator unit 8006, a device info manager unit 8009, a device authenticator processor unit 8010, a key manager unit 8011, a key generator unit 8012, a decryption processor 8013, a remote access discovery agent unit 8014, a remote access client unit 8015, a remote access transport agent unit 8016, a communication processor unit 8017, a device detector unit 8021, a streaming coupling controller 8003, a content directory controller 8004, a media receiving controller 8007, a device info service 8008, a contents viewing application 8019, a setting application 8020.

When recording contents in the recording media 716, the contents manager unit 8001 acquires content information for those contents from the content transmission source by way of the network and records that content information in the memory 710 or in the recording media 716. The contents manager unit 8001 executes the linking of the content with its content information, updating the content information when the contents are deleted or moved, and monitoring the number of copies for contents that are allowed only a certain number of copies, etc.

The contents info acquisition unit 8002 retains metadata information for contents that are acquired by the content directory controller 8004, and generates a UI (User interface) screen to provide information for contents capable of being acquired by the user over a network.

The device authentication processor unit 8010 authenticates whether or not devices are mutually authorized in conformance with designated authentication protocols among the other devices in order to send and receive contents subject to copyright protection by way of wireless network, and shares a key for utilizing in encrypting and decrypting of data or contents with the other devices only when the authentication is a success.

The device info manager unit 8009 acquires from the device authentication processor unit 8010, information (unique information and address information, etc.) relating to devices coupled over the network where authentication by the device authentication processor unit 8010 is a success and manages tasks such as registration, updating, and deleting, etc. This information is retained in the memory 710.

When authentication by the device authentication processor unit 8010 is a success, the key manager unit 8011 acquires the key shared among the devices coupled over a network and attachment information relating to the key (information relating to the label and the data for management by the device manager unit 8009), from the device authentication processor unit 8010, and manages tasks such as registration, updating, and deleting, etc. This information is retained in the memory 710.

The key generator unit 8012 acquires keys and attachment information for management by the key manager unit 8011 when receiving data and contents between devices where authentication by the device authentication processor unit 8010 is successful, and generates an encryption key in conformance with a specified algorithm by utilizing them. The key generator unit 8012, periodically updates (or rewrites) the decryption key in conformance with the specified protocol.

When receiving data or contents from a device coupled to the network by way of the communication processor unit 8017, the decryption processor 8013 sets a decryption key that is acquired from the key generator unit 8012, into the encrypter/decrypter unit 718 within the wireless communications unit 708 of FIG. 5 and performs decrypting of the data or contents. The decryption processor 8013 acquires a new decryption key each time the decryption key is updated in the key generator unit 8012 and changes the decryption key. Here, the decrypted data or contents are recorded in the recording media 716 by the record-play unit 709, or are output to the demax unit 701, and played by the voice output unit 706 and a display unit 707. Here, when recording the decrypted contents in recording media 716, the record-play unit 709 performs encryption by utilizing its own encrypter/decrypter unit 719 as needed.

The communication processor unit 8017 performs analysis of the communication protocol and flow control of the communication data. The communication processor unit 8017 contains a local network communication processor unit and a remote access communication processor unit; and processes the communication data according to the communication protocol when sending and receiving content and control messages among other devices that are respectively coupled. The communication data is sent and received by way of the wireless communication unit 708 and the wireless network terminal 715 in FIG. 5. Here, the communication processor unit 8017 may send and receive the communication data by way of the wideband wireless communication unit 720 instead of the wireless communication unit 708. Methods may include for example, the user sets in advance, for the setting application 8020 on the mobile device 700 under an environment capable of using both the wireless communication unit 708 and the wideband wireless communication unit 720 so as to give usage priority to either of these devices, and based on this setting, to decide which device the communication processor unit 8017 will use; or a method to utilize the wideband wireless communication unit 720 when an appropriate wireless access point 20 cannot be detected in the periphery of the mobile device 700 while the communication processor unit 8017 is performing communication; or a method where the user designates which of either the setting application 8020 or the contents viewing application 8019 to use, and the communication processor unit 8017 acquires that content and switches to one of those devices, etc.

The remote access discovery agent unit 8014 detects devices coupled to the network within the user home 1 by way of the remote access communication processor unit in the communication processor unit 8017. The remote access discovery agent unit 8014 acquires information relating to devices coupled to the network within the user home 1 from the device within the user home 1 by way of the remote access communication processor unit in the communication processor unit 8017, and provides the acquired information relating to the coupled device, to the coupled device by way of the local network communication processor unit in the communication processor unit 8017. The remote access discovery agent unit 8014 also monitors exchanges such as search requests among devices coupled by way of the remote access communication processing unit in the communication processor unit 8017 and those replies, and a coupling notification and a decoupling notification, and when a change occurs in the coupled state or the device state, gives notification of the status change to the device within the user home 1 by way of the remote access communication processor unit in the communication processor unit 8017 as needed.

The remote access client unit 8015 contains a coupling setting info manager unit 8018 that executes and manages the required settings for remote access to the device within the user home 1 from outside the home by way of the local network communication processor unit in the communication processor unit 8017.

The remote access transport agent unit 8016 utilizes the environmental setting information (device info table 1110 that is described later on) managed by the coupling setting information processor unit 8018, to establish a secure communication path with the specified device (router 500 in the present embodiment) in order to communicate with the device coupled to the network within the user home 1 by way of the remote access communication processor unit in the communication processor unit 8017. The remote access transport agent unit 8016 for example utilizes pre-existing technology (plural combinations are also allowed) such as IPsec (Security Architecture for Internet Protocol) or SSL (Secure Socket Layer)/TLS (Transport Layer Security) to establish a communication channel with the router 500 and unauthorized usage and tampering with communication data.

The device detector unit 8021 detects notification of a coupling or decoupling (or namely connection or disconnection) to a network of another device, and when a connection to a device for control is detected, acquires device information or service information that is provided for that device. Moreover, the device detector unit 8021 sends a device search request to search for a desired device for control over the network.

The streaming coupling controller 8003 requests information for the data format, the type of transfer protocol and contents, for the other device.

The content directory controller 8004 requests and acquires metadata information such as the content title and genre from the contents viewing application 8019, etc. The content directory controller 8004 outputs the acquired metadata information to the contents info acquisition unit 8002.

The media receiving controller 8007 receives contents sent by way of the in-home network (namely the network within the user home 1), the access network 12, or Internet 13, and records them in the recording media 16 in the record-play unit 709 or outputs them to the demax unit 701. The media receiving controller 8007 sends command that control the content distribution such as start, stop, pause, or skip from user operation, to the content distribution source.

The contents viewing application 8019 is an application for providing to the user a function for acquiring and viewing contents that are provided by the device which is coupled by way of the local network communication processor unit or the device which is coupled by way of the remote access communication processor unit in the communication processor unit 8017. The contents viewing application 8019 controls for example, the device detector unit 8021 or the remote access discovery agent unit 8014, the content directory controller 8004, the media receiving controller 8007, the remote access client unit 8015, and the remote access transport agent unit 8016 and acquires content and information relating to the contents.

The setting application 8020 is an application that provides to the user, environmental settings required for communication of control commands or data and contents between other devices by way of the communication processor unit 8017. The setting application 8020 controls for example the device detector unit 8021 or the remote access discovery agent unit 8014, the remote access client unit 8015, and the communication processor unit 8017, and makes the communication settings.

Here, the contents viewing application 8019 and the setting application 8020 include relations of the control and the reference of data with nearly all the software blocks that configure the control software 8000, however the lines relating to other software blocks are omitted due to the resulting complexity in the drawings.

Sections other than described above include the same functions as in FIG. 7.

The software configuration example for the TV having storage playback function 200 is not shown in the drawings however it includes a configuration identical to the software configuration of the above described STB having storage playback function 100; in order to provide the received contents on the tuner 201 or contents recorded on the recording media 223 to another device (for example, STB300 or mobile device 700) coupled to an in-home network by way of the communication unit 210. Moreover, in order for the TV having storage playback function 200 to receive and view the contents from another device (for example, the STB having storage playback function 100) coupled to the in-home network via the communication unit 210, the configuration example includes the same structure as the software structure of the mobile device 700 (except for the remote access discovery agent unit 8014, the remote access client unit 8015, and the remote access transport agent unit 8016).

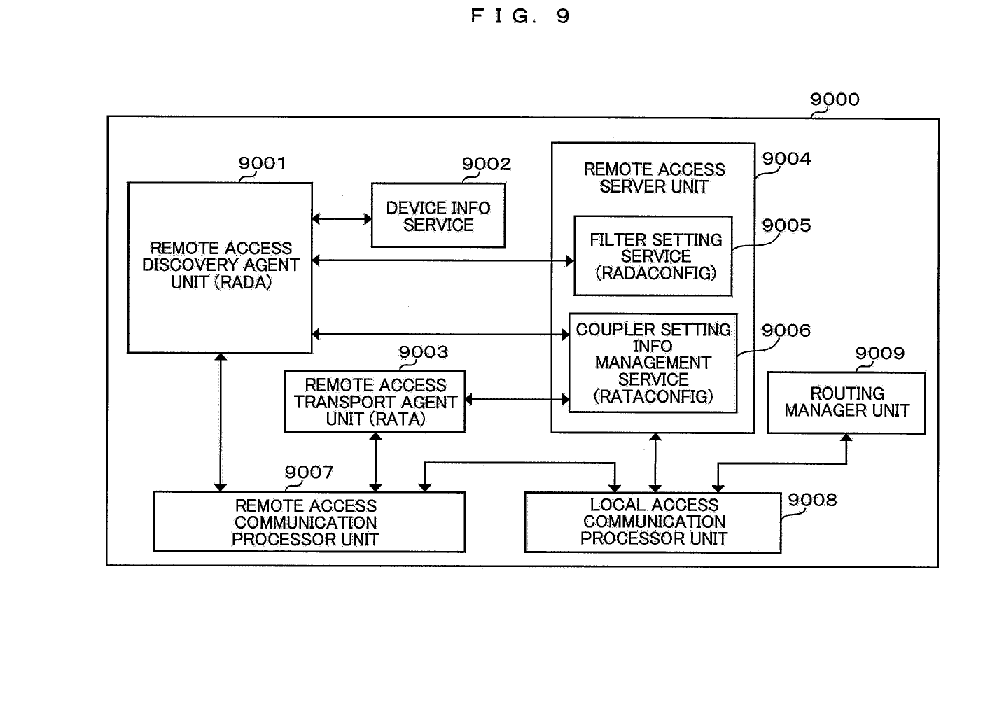

FIG. 9 is a drawing showing a configuration example of the software for the router 500 shown in FIG. 6.

The control software 9000 that implements the router 500 function is operated in the memory 501 and executed by the control unit 502 of the router 500.

The control software 9000 is comprised of the remote access discovery agent unit 9001, the remote access transport agent unit 9003, the remote access server unit 9004, the remote access communication processor unit 9007, the local access communication processor unit 9008, and the routing manager unit 9009. FIG. 9 describes the software 9000 divided into functional blocks, and each block can be divided or unified. Moreover the control software 9000 need not be implemented on one program and can be implemented even by a combination of two or more programs.

The remote access discovery agent unit 9001 detects devices coupled to the network within the user home 1 from outside the home by way of the remote access communication processor unit 9007. The remote access discovery agent unit 9001 acquires information relating to devices that can be coupled from outside the home by way of the remote access communication processor unit 9007, and provides the acquired information relating to the coupled devices, to the device that is coupled by way of the local access communication processor unit 9008. The remote access discovery agent unit 9001 also monitors exchanges such as a coupling notification and a decoupling notification, and search requests and those replies among devices coupled by way of the local access communication processor unit 9008, and when a change occurs in the coupled state or the device state, gives notification of the status change to the out-of-home device by way of the remote access communication processor unit 9007 as needed.

The remote access server unit 9004 includes a filter setting service 9005 and a coupling setting info management service 9006. The remote access server unit 9004 checks whether or not the environment is capable of remote accessing by devices within the user home 1 from outside the home by utilizing pre-existing technology such as STUN (Simple Traversal of UDP through NAT) client function. Also, the IP address that the communication provider 5 assigns to the remote access communication unit 505 of the router 500 might possibly dynamically change so that the remote access server unit 9004 notifies the pre-registered DDNS server when the assigned IP address is updated by generally utilizing the DDNS client function in which the communication provider or communication carrier provide free or billable services.

The filter setting service 9005 manages environmental setting information and filter information for providing information relating to a device within the user home 1 coupled by way of the local access communication processor unit 9008 to out-of-home devices coupled by way of the remote access communication processor unit 9007. The filter setting service 9005 in the same way, manages the environmental setting information and filter information for providing information relating to out-of-home devices coupled by way of the remote access communication processor unit 9007, to devices within the user home 1 coupled by way of the local access communication processor unit 9008. This information is provided to the remote access discovery agent unit 9001.

The coupler setting info management service 9006 provides an IF for setting the environmental settings required for the remote access transport agent unit 9003 to establish a communication path with out-of-home devices by way of the remote access communication processor unit 9007, and manage the information that is set.

The remote access transport agent unit 9003 utilizes the environmental setting information (out-of-home device info table 1440 outside the home that is described later on) that is managed in the coupling setting information management service 9006 to establish a secure communication path with the out-of-home device (mobile device 700 in the present embodiment) by way of the remote access communication processor unit 9007. Pre-existing technology may be utilized such as IPsec or SSL/TLS to establish secure communication path (plural combinations are also allowed).

The remote access communication processor unit 9007 performs processing of communication data in compliance with the communication protocol when sending and receiving control messages and contents with devices outside the home; and is capable of coupling to the Internet 13 by way of the access network 12 in FIG. 1, via the out-of-home network coupling terminal 513 and the remote access communication unit 505 in FIG. 6.

The local access communication processor unit 9008 performs processing of communication data in compliance with the communication protocol when sending and receiving control messages and contents with devices within the user home 1, by way of the local access communication unit 508, and the cable network coupling terminal 514 or wireless network communication terminal 515 of FIG. 6.

The routing manager unit 9009 manages the routing table required for relaying communications between a device coupled to the out-of-home network and a device coupled to a network within the user home 1, and sets the communication path.

### <Structure of Device Information Utilized in Each Device>

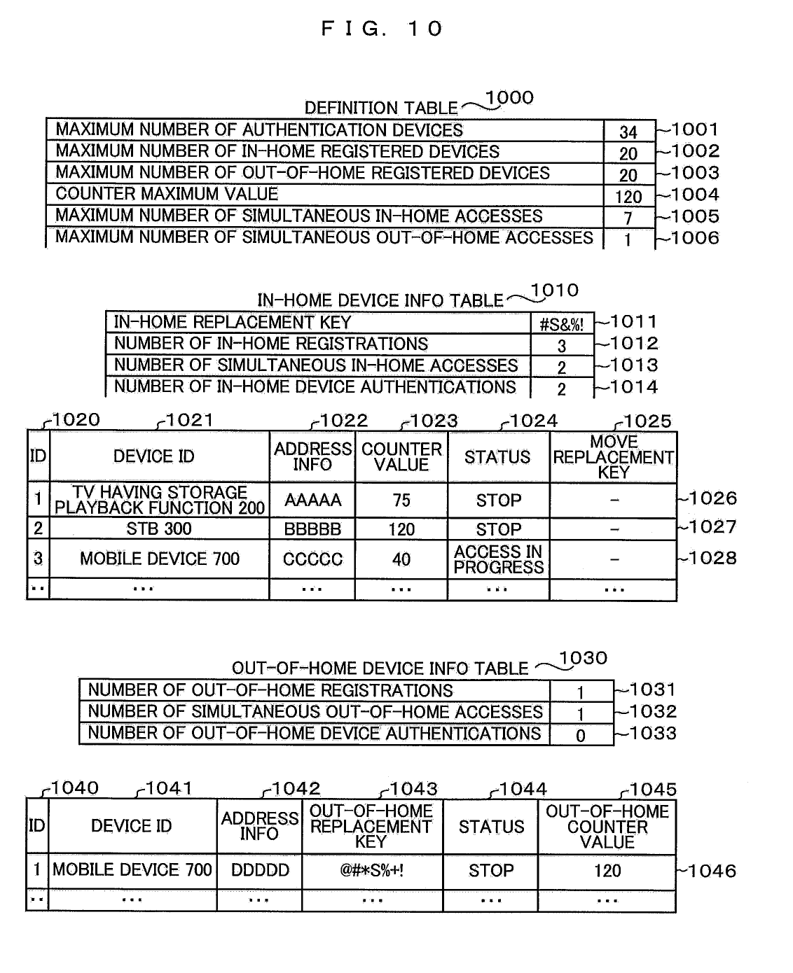

FIG. 10 is one configuration example of the device information utilized in the device info service 7008 and the device info manager unit 7009 of the STB having storage playback function 100. This information is stored in the memory 110.

The device information is comprised of the definition table 1000, the in-home device info table 1010, and the out-of-home device info table 1030.

The definition table 1000 is comprised of the maximum number of authentication devices 1001, the maximum number of in-home registered devices 1002, the maximum number of out-of-home registered devices 1003, the counter maximum value 1004, the maximum number of simultaneous in-home accesses 1005, and the maximum number of simultaneous out-of-home accesses 1006.

The maximum number of authentication devices 1001 shows the maximum number capable of being authenticated in the device authentication processor unit 7010 of FIG. 7, and may be set to “34” for example.

The maximum number of in-home registered devices 1002 shows the maximum number of device capable of being registered within the home, and may be set to “20” for example.

The maximum number of out-of-home registered devices 1003 shows the maximum number of devices for access outside the home capable of being registered and may be set to “10” for example. If the device in which the maximum number of in-home registered devices 1002 and the maximum number of out-of-home registered devices 1003 are the same value, either value may be used.

The counter maximum value 1004 shows the maximum value for the validity period of information that is registered in the in-home device info table 1010 or the out-of-home device info table 1030, and may be set to “120 minutes” for example. The time management/timer 113 of FIG. 3 is utilized for measuring the time of the validity period. When the device that is set separate validity periods in the in-home device info table 1010 and in the out-of-home device info table 1030, the definition table 1000 may separately utilize the maximum counter value for in-home use, maximum counter value for out-of-home use as the definition values.

The maximum number of simultaneous in-home accesses 1005 shows the maximum number of content access requests that are allowable in the home and may be set to “7” for example.

The maximum number of simultaneous out-of-home accesses 1006 shows the maximum number of content access request allowable from outside the home, and may be set to “1” for example. When the device that has the same value in the maximum number of simultaneous in-home accesses 1005 and the maximum number of simultaneous out-of-home accesses 1006, the definition table 1000 may utilize either value.

The in-home device info table 1010 is comprised of an in-home replacement key 1011, a number of in-home registrations 1012, a number of simultaneous in-home accesses 1013, and a number of in-home device authentications 1014, and ID 1020 as information relating to one device, a device ID 1021 an address info 1022, a counter value 1023, a status 1024, and a MOVE replacement key 1025.

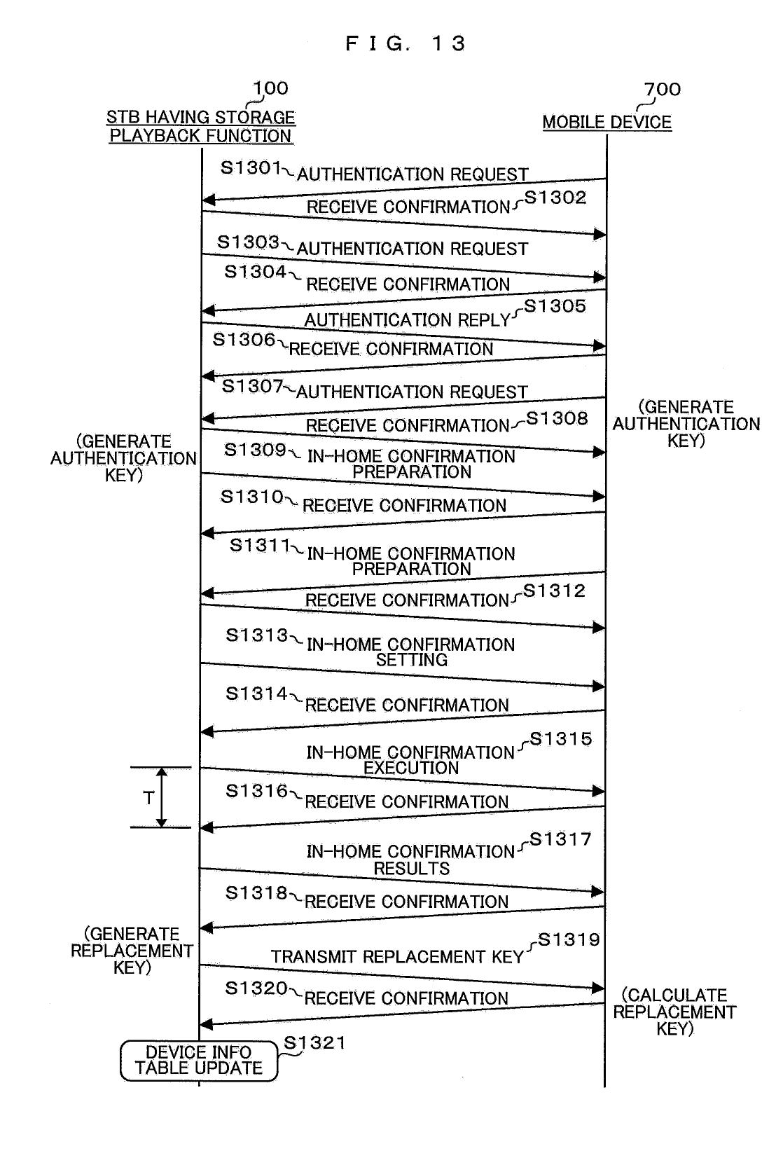

The in-home replacement key 1011 shows results from device authentication processing that are executed in the device authentication processor unit 7010 in FIG. 7, and key information and its additional information (such as type of label and key) and shared among other devices. The details are shown in FIG. 13.

The number of in-home registrations 1012 shows the number of device currently registered in the in-home device info table 1010. If this value reaches the above described maximum number of in-home registered devices 1002, the device info manager unit 7009 does not accept any more registration request from then onwards or makes a new registration after deleting one registration.

The number of simultaneous in-home accesses 1013 shows the number of devices that are already coupled during receiving of contents or the receiving of content that is attempting to start with its own device. When this value reaches the maximum number of the above described simultaneous in-home accesses 1005, the STB having storage playback function 100 does not send more contents from then onwards or does not accept content transmit requests from other devices.

The number of in-home device authentications 1014 executes device authentication with devices coupled in the in-home network, and shows the number of devices sharing the in-home replacement key 1011. When the total of this value and the latter described number of out-of-home device authentications 1033 reaches the above described maximum number of authentication devices 1001, the device authentication processor unit 7010 rejects device authentication requests that are issued from other devices from then onwards.

The ID 1020 shows the table registration number.

The device ID 1021 shows the identifier for uniquely identifying each device. The device ID 1021 is generated by a designated authentication organization, and is stored in advance in the non-volatile memory of the memory 110 during the manufacture of each device, or is unique device information recorded in the non-volatile memory for safety after the designated registration processing after purchase, and is a unique value for each device. The device ID 1021 may include other information such as public key.

The address info 1022 shows the MAC address and IP address (IPv4/IPv6) of each device in the network. The IP address may be limited to address formats expected to be utilized within the home such as private addresses or local addresses, etc.

The counter value 1023 shows the current counter value for in-home usage and is set in the time management/timer 113.

The status 1024 shows the content transmission status (for example, access-in-progress, stopped, etc.) to other devices in the in-home network. The MOVE replacement key 1025 shows the key information and its additional information (type of label or key, etc.) utilized in the encryption processing during movement (MOVE) of contents to another device on the in-home network. The MOVE replacement key is jointly shared with other devices in conformance with a specified procedure and contains a value differing for each device at the content transmission destination, whose usage method differs from that of the in-home replacement key 1011.

FIG. 10 shows as examples, the device information 1026 for the TV having storage playback function 200, the device information 1027 for the STB300, and the device information 1028 for the mobile device 700.

The out-of-home device info table 1030 is comprised of a number of out-of-home registrations 1031, a number of simultaneous out-of-home accesses 1032, a number of out-of-home device authentications 1033, an ID 1040 as information relating to one device, a device ID 1041, an address info 1042, an out-of-home replacement key 1043, a status 1044, and an out-of-home counter value 1045.

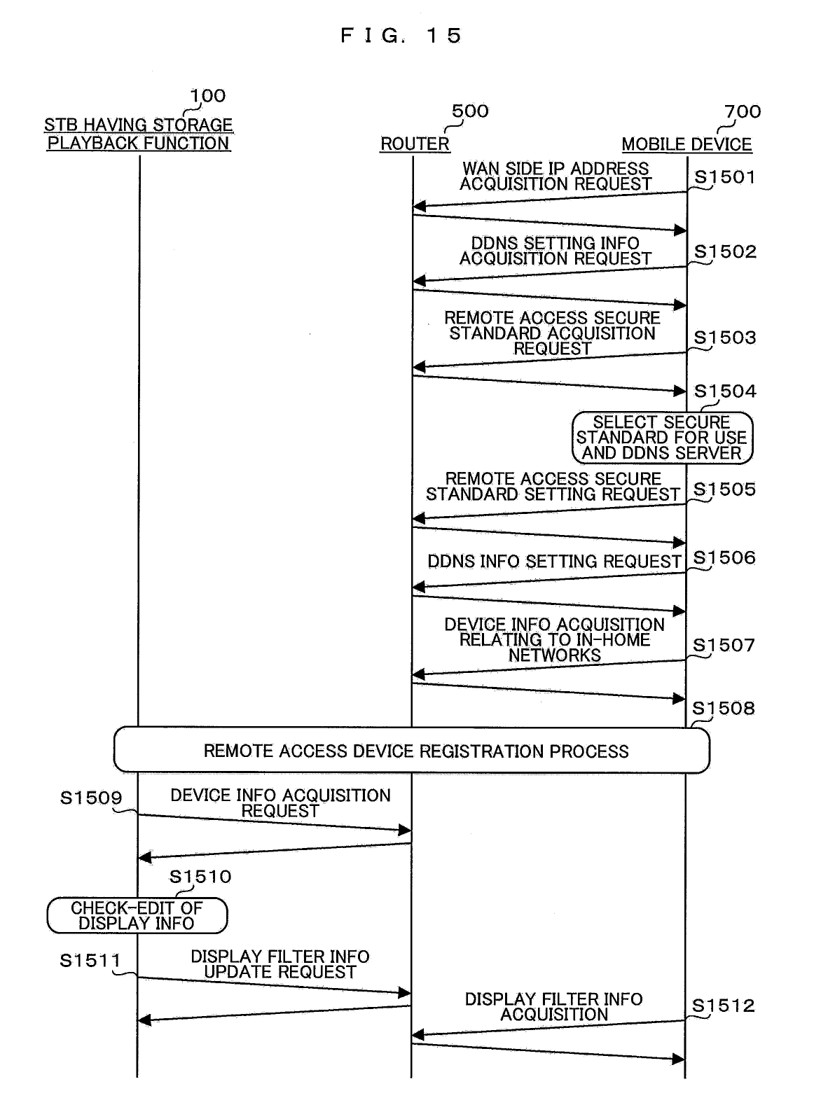

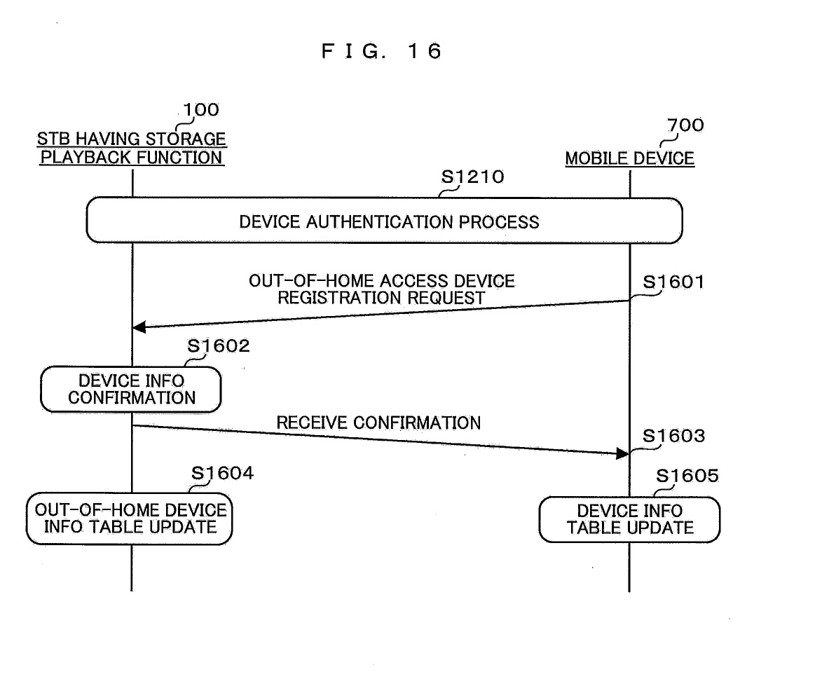

The number of out-of-home registrations 1031 shows the allowable number of registration of devices for remote access to its own device from outside the home. The registration procedure is described in the latter described FIG. 15 and FIG. 16. When this value reaches the above described maximum number of out-of-home registered devices 1003, the device info manager unit 7009 does not accept any more registration request from then onwards or makes a new registration after deleting one registration.

The number of simultaneous out-of-home accesses 1032 shows the number of devices outside the home that are already coupled during receiving of contents or the receiving of content that is attempting to start with its own device. When this value reaches the above described maximum number of simultaneous out-of-home accesses 1006, no content transfer is executed from then onwards or no content transmit requests from other devices are accepted.

The number of out-of-home device authentications 1033 executes authentication processing of out-of-home access devices among devices couple on the out-of-home network, and shows the number of devices sharing the out-of-home replacement key 1037. When the total of this value and the previously described number of in-home device authentications 1014 reaches the previously described maximum number of authentication devices 1001, the device authentication processor unit 7010 rejects device authentication requests that are issued from other devices from then onwards.

The ID 1040 shows this table registration number.

The device ID 1041 shows the identifier for uniquely identifying each device, and is the information the same as the previously described device ID 1016.

The address info 1042 shows the IP address and MAC address, URI (Uniform Resource Identifier) of the content receiver device for access from outside the home.

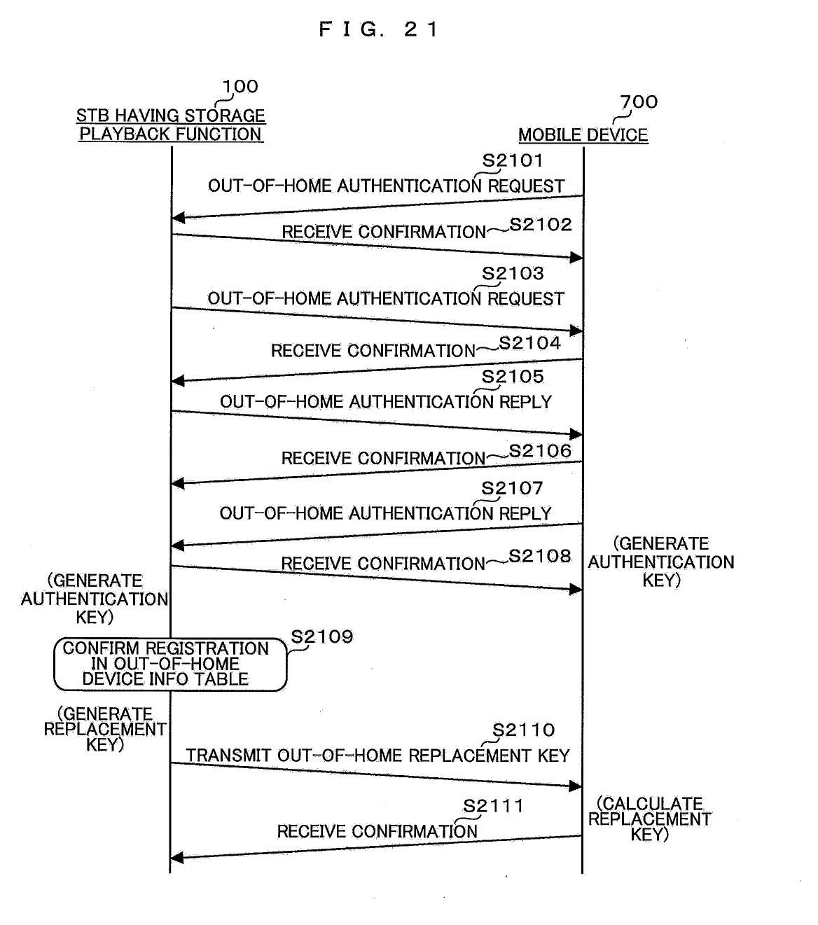

The out-of-home replacement key 1043 shows results from authentication processing of device for out-of-home access that is executed in the device authentication processor unit 7010 of FIG. 7, and key information and its additional information (such as type of label and key) shared among other devices. The details are shown in FIG. 21.

The status 1044 shows the content transmit status (for example, access-in-progress, stopped) to devices outside the home.

The out-of-home counter value 1045 shows the current value of the out-of-home counter set in the timer 1091.

FIG. 10 shows as an example the device info 1046 for the mobile device 700.

In this embodiment, the counter value 1023 and the out-of-home counter value 1045 are separately installed in the in-home device info table 1010, and the out-of-home device info table 1030, however the counter value 1023 of the in-home device info table 1010 may be jointly shared.

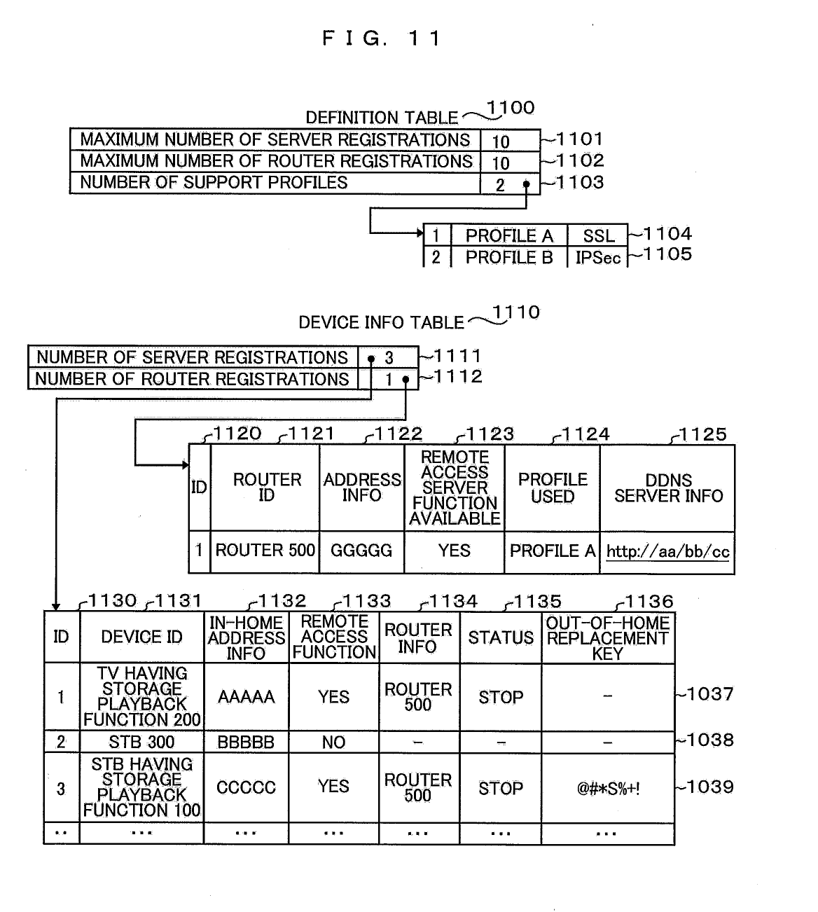

FIG. 11 is a configuration example of the device information that is handled in the device info service 8008 and the device info manager unit 8009 for the mobile device 700. This device information is stored in the memory 710.

The device information is comprised of the definition table 1100 and the device info table 1110.

The definition table 1100 is comprised of the maximum number of server registrations 1101, the maximum number of router registrations 1102, the number of support profiles 1103, and the detailed info (profile A) 1104, (profile B) 1105 relating to the support profiles.

The maximum number of server registrations 1101 shows the maximum number of allowable registrations of devices providing contents to the mobile device 700, and is set to “10” for example.

The maximum number of router registrations 1102 shows the maximum number of possible router registrations when the mobile device 700 does remote accessing from outside the home, and is set to “10” for example.

The number of support profiles 1103 shows the number of supports for coupling information profile that are used for establishing a secure communication channel by the remote access transport agent unit 8016 in FIG. 8, with the remote access transport agent unit 9003 of the router 500 in the network for remote accessing destination by way of the communication processor unit 8017; and is set to “2” for example.

The detailed info “profile A” 1104 and the detailed info “profile B” 1105 relating to the support profiles show detailed information of the coupling information profile that is defined just for the number shown by the number of support profiles 1103, and for example includes information that is related to protocol names and versions such as IPsec or SSL/TLS used for secure data communication, package names for software for install (for example, Open SSL or Open VPN) and key information.

The device info table 1110 is comprised of the number of server registrations 1111, the number of server registrations, the number of router registrations 1112, the router ID 1120 for information relating to one router, an address info 1121, a remote access server function available 1123, a profile used 1124, a DDNS server info 1125, an ID 1130 as information relating to one device, a device ID 1131, an in-home address info 1132, a remote access function 1133, a router info 1134, a status 1135, and an out-of-home replacement key 1136.

The number of server registrations 1111 shows the number of content provider devices currently registered in the device info table 1110.

The number of router registrations 1112 shows the number of routers currently registered in the device info table 1110.

The router ID 1120 shows the identifier for uniquely identifying the router registered here.

The address info 1121 shows the IP address or MAC address, and URI, etc.

The remote access server function available 1123 shows whether or not the remote access server unit 9004, the remote access discovery agent unit 9001, and the remote access transport agent unit 9003 functions are contained in the router.

The profile used 1124 shows the type of coupling information profile that describes the setting information required for establishing a secure channel when remotely accessing this registered router. In the present embodiment, the “Profile A” 1104 is utilized from among the above described support profile “Profile A” 1104 and “Profile B” 1105, and the remote access transport agent unit 8016 searches this information and establishes a secure communication path with the router 500.

The DDNS server into 1125 shows information relating to the DDNS server that is utilized for acquiring an IP address for the WAN (Wide Area Network) side allocated to the remote access communication unit 505 of the router 500 from the communication service provider 5, when the router 500 is remotely accessed from outside the home. The value set in the DDNS server info 1125 is for example information such as the address information or user name, and password for accessing the DDNS server.

The ID 1130 shows the registration number for the content provider device registered in the device info table 1110.

The device ID 1131 shows an identifier for uniquely identifying each content provider device.

The in-home address info 1132 shows the IP address or MAC address, and URI of the each content provider device. The remote access function 1133 shows whether or not each content provider device contains a function to send contents to the device that has remotely accessed device. The value set in the remote access function 1133 shows for example whether or not the device authentication processor unit 7010 of each device supports the out-of-home access device authentication process 2005 described later on.

The router info 1134 shows information relating to the router coupled to each content provider device.

The status 1135 shows the content receiving status (for example, access-in-progress and stop, etc.) from each content provider device.

The out-of-home replacement key 1136 shows the key information and its additional information (such as type of label and key) jointly shared between each device, and results of the out-of-home access device authentication processing that is executed by the device info manager unit 7009 of the each device. Details are described in FIG. 21.

<Content Viewing within the Home>

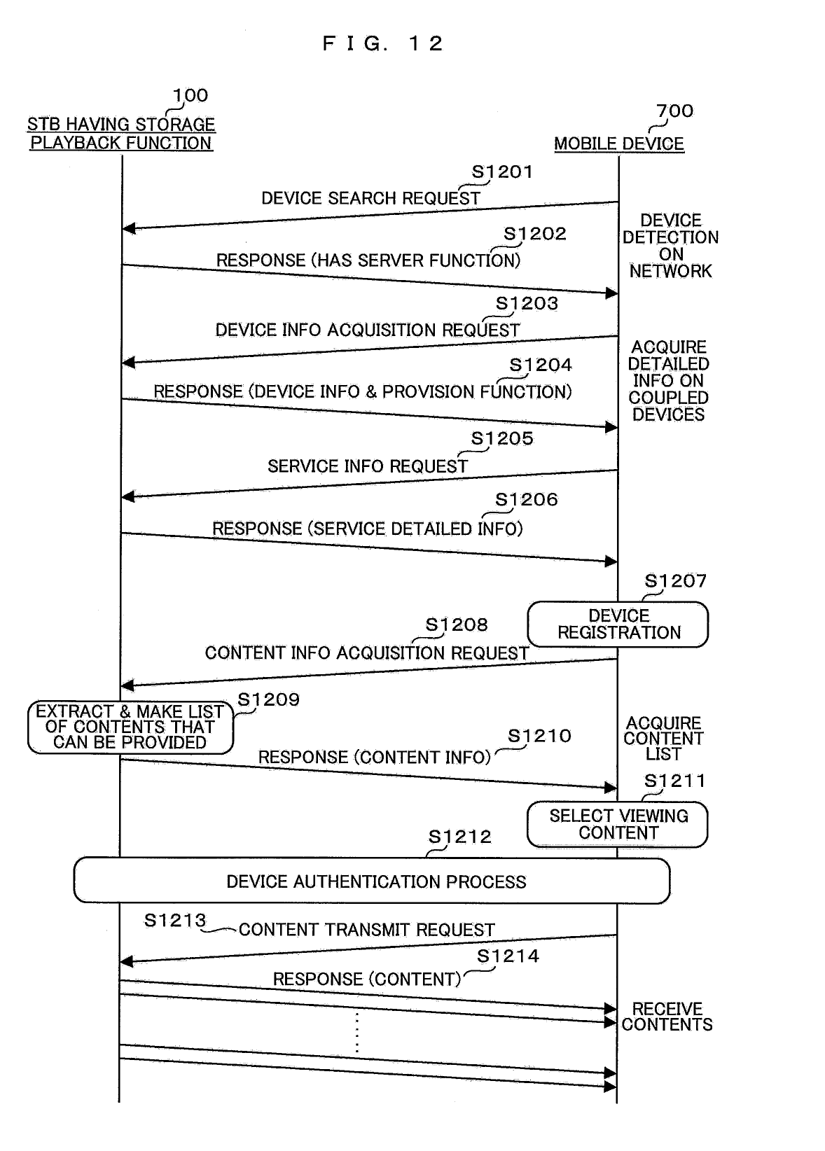

FIG. 12 is one example of the processing sequence when viewing contents that are accumulated in the recording media 119 for the STB having storage playback function 100 by the user using the mobile device 700 within the user home 1. The data sending and receiving for establishing and discarding a connection via TCP is omitted in FIG. 12.

When the operating IF unit 712 of the mobile device 700 accepts the operation by the user and starts the contents viewing application 8019, the device detector unit 8021 acting on instructions from the content viewing application 8019 generates a “device search request” message in the message generator unit 8006 in order to search server containing a function for content distribution, and sends the message to all devices comprising the home network by way of the local network communication processor unit in the communication processor unit 8017 (S1201). Here, messages after transmission to the other devices are generated in the message generator unit 8006.

The STB having storage playback function 100 that receives the “device search request” message for searching the content distribution devices, processes that message in the device info service 7008 by way of the message analysis unit 7016. The STB having storage playback function 100 contains a content distribution function and so the device information service 7008 generates a message including a URI showing the acquisition destination of its own device description information by utilizing the message generator unit 7017, and replies to the mobile device 700 by way of the communication processor unit 8017 (S1202). Here, messages after sending that message to the other devices are generated in the message generator unit 7017.

The device detector unit 8021 of the mobile device 700 that receives the reply, accesses the URI containing the reply message, and sends a “device information acquisition request” message for requesting device description information to the STB having storage playback function 100 (S1203).

The STB having storage playback function 100 that receives the “device information acquisition request” message for the acquisition destination URI with the device description information, processes that message in the device information service 7008 by way of the message analysis unit 7016. Then, the device information service 7008 generates a message including its own device description information and replies to the mobile device 700. The device information is described in a reply message in a format such as XML (Extensible Markup Language) (S1204).

The device detector unit 8021 of the mobile device 700 that receives the reply, analyzes the reply message, and confirms that the STB having storage playback function 100 provides services such as a content directory service, a media distribution service, and a streaming coupling service, accesses the service description URL of each service, and sends a “service information request” message for requesting detailed information on the service to the STB having storage playback function 100 (S1205).

The STB having storage playback function 100 that receives the “service information request” message for the service description URL of the content directory service 7007, the media distribution service 7015, and the streaming coupler service 7014 processes that message in the device information service 7008. The STB having storage playback function 100 then generates a reply message containing detailed information on the service including the service status table and action list for utilizing the service, and replies to the mobile device 700 (S1206).

The device detector unit 8021 of the mobile device 700 that receives the reply conveys the service detailed information of the content directory service to the content directory controller 8004. Moreover, the device detector unit 8021 conveys the service detailed information of the media distribution service 7015 to the media receiving controller 8007, and the service detailed information of the streaming coupler service 7014 to the streaming coupling controller 8003. Each controller analyzes the service detailed information and recognizes the action that each service provides. The device detector unit 8021 makes a request to the device info manager unit 8009 to register the TB having storage playback function 100. The device info manager unit 8009 registers the TB having storage playback function 100 in the device info table 1110 of FIG. 11. More specifically, an ID 1130 is added, and after then registering the in-home address info 1132 and device ID 1131 of the STB having storage playback function 100, the number of server registrations 1111 is incremented (counts up) by +1 (S1207).

The contents viewing application 8019 of the mobile device 700 then displays the device registered in the device info table 110 on the display unit 707. When the user then selects the device that is desired for viewing (in the case of the present embodiment, the STB having storage playback function 100) by way of the operating IF unit 712, the content directory controller 8004 complies with instructions from the contents viewing application 8019 and sends an action “content information acquisition request” message for utilizing the content information provider service, to the content directory service 7007 for the STB having storage playback function 100 (S1208).

The STB having storage playback function 100 that receives the “content information acquisition request” message processes that message in the content directory service 7007. The content directory service 7007 first of all, acquires information on contents that the STB having storage playback function 100 is capable of providing to other devices configuring the home network 11 from the contents info provider unit 7006. The contents info provider unit 7006 acquires information regarding the contents that are recorded in the recording media 119 from the contents manager unit 7005, searches this information and the current status (whether or not a content transfer status) of the device as needed, extracts the information on contents that can be provided, and notifies the content directory service 7007. The content directory service 7007 generates a message containing content information (name of content, format, information provision source, time copy limit information, URI required for viewing and port information, etc.) capable of being provided by using this information (S1209), and replies to the mobile device 700 (S1210).

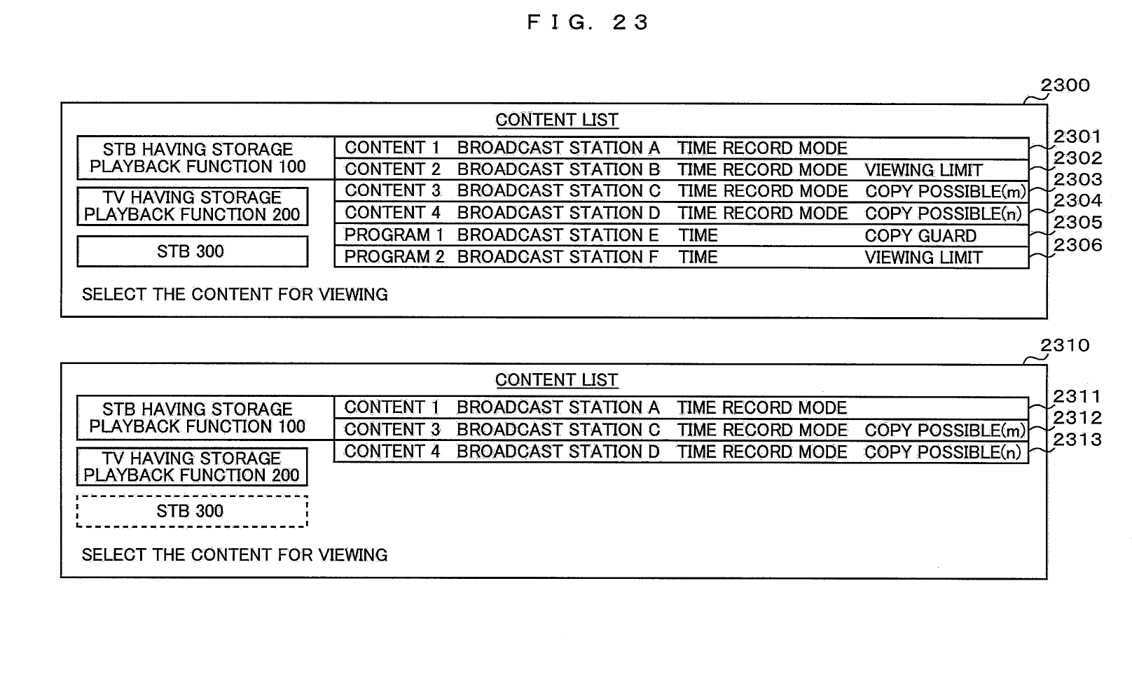

The contents viewing application 8019 of the mobile device 700 that receives the reply message containing the content information utilizes this information for example to generate a content list 2300 that is shown in FIG. 23 and display it on the display unit 707.

Devices capable of providing contents via a network such as for the STB having storage playback function 100, the TV having storage playback function 200, and the STB300 that are detected by the procedure in S1201 through S1205 and that are registered in the device info table 1110 are displayed on the content list 2300. When the user selects the STB having storage playback function 100 from among these, the content viewing application 8019 acquires information for contents capable of being provided by the STB having storage playback function 100 using the procedures in the previously described S1208 through S1210 and displays them on the screen of the content list 2300. The contents in this case include the contents 2301 through 2304 recorded in the recording media 119, and the programs 2305 through 2306 capable of being received or currently being broadcast per the tuner 101. Information displayed as the contents 2301 through 2304 recorded in the recording media 119 is for example the content name, information relating to the source providing the content (names for broadcast station or the IP distribution provider, etc.), the playback time, the HD or SD, recording mode such as double speed, and information on each type of limit (viewing limit or copy control information). Information displayed for the programs 2305 through 2306 is for example the program name, information relating to the source providing the program (broadcast station or channel number, etc.), and information on the playback time, record mode, and type of limit. The method for displaying content information on the screen of the content list 2300 other than the method for displaying all of the content information acquired from the content directory service 7007 for the STB having storage playback function 100, is method that displays only contents capable of being handled by the contents viewing application 8019 or the streaming coupling controller 8003, and the media receiving controller 8007.

After receiving the optional contents on the screen of content list 2300 selected by the user operating the operating IF unit 712 (S1211), the contents viewing application 8019 of the mobile device 700 instructs the STB having storage playback function 100 to conduct an authentication processing in the device authenticator processor unit 8010 in order to have the STB having storage playback function 100 authenticate the contents as legitimate viewing contents. The device authenticator processor unit 8010 executes device authentication processing with the device authentication processor unit 7010 for the STB having storage playback function 100 by way of the communication processor unit 8017 (S1212). When the device authentication processing is a success, the device authenticator processor unit 8010 of the mobile device 700 jointly shares information needed for encrypting and decrypting the contents with the device authentication processor unit 7010 for the STB having storage playback function 100, and notifies the contents viewing application 8019 of the results from the device authentication processing.

When the above described device authentication processing is a failure, the contents viewing application 8019 of the mobile device 700 displays an error message screen on the display unit 707, and notifies the user that viewing of the selected contents is impossible. When the device authentication processing is a success, the contents viewing application 8019 instructs the media receiving controller 8007 to start acquiring the content. The media receiving controller 8007 generates a “content transmission request” message and sends it to the STB having storage playback function 100 by way of the communication processor unit 8017 (S1213).

The STB having storage playback function 100 that receives the “content transmission request” message by way of the communication processor unit 7018, process this message in the media distribution service 7015 by way of the message analysis unit 7016. The media distribution service 7015 gives instructions to the key generator unit 7012, the encryption processor unit 7013, and the contents manager unit 7005, to read out the contents recorded in the recording media 119 on the record-play unit 109, encrypt on the encrypter/decrypter unit 122 when necessary, generate an encryption key in the key generator unit 7012 based on information jointly held for those contents in the above described device authentication processing S1212, encrypt the contents by using this encryption key in the encryption processor 7013, and send them by way of the communication processor unit 7018 to the mobile device 700 (S1214). Here, the algorithm for encrypting the contents may utilize for example existing encryption technology such as AES (Advanced Encryption Standard) or M6, and 3DES (Data Encryption Standard).

The content viewing application 8019 or the media receiving controller 8007 of the mobile device 700 that receives the encrypted contents by way of the communication processor unit 8017, instructs the key generator unit 8012 and a decryption processor 8013 to generate a decryption key based on information jointly held in the above described device authentication process S1212, and decrypts the contents by utilizing this decryption key in the decryption processor 8013. The contents viewing application 8019 or the media receiving controller 8007 then separates the decrypted contents into audio data and video data in the demax unit 701, and outputs the audio data to the voice decoder unit 702 to decode and outputs it to the voice output unit 706, and to decode the video data in the video decoder unit 703 and output it to the display unit 707.

The above procedure allows the user to view the contents accumulated in the recording media 119 of the STB having storage playback function 100 by utilizing the mobile device 700 within the user home 1.

A search is made here in S1202 of the contents in the device info table 1110 in S1207 and the contents in the reply from the STB having storage playback function 100, and may skip S1203, or both S1204 and S1205 when this STB having storage playback function 100 is already registered.

Also in S1203 through S1206, when the contents info provider unit 7006 and the content directory service 7007, the device authentication processor unit 7010, the device info manager unit 7009 contain a function to provide copyright protected contents to outside the home, the fact that this function is contained may be given in the provided functions or service detail information as a reply.

FIG. 13 is one example of the device authentication process sequence S1212 executed between the mobile device 700 and the STB having storage playback function 100 within the user home 1. The authentication process described in FIG. 13 is hereafter referred to as normal authentication.

Here, TCP is utilized as the protocol for sending and receiving the information for device authentication processing, and the receiving confirmation for each type of information such as authentication requests to the device of the other party and authentication replies to those requests are sent back from the device of the other party, to in this way secure a communication path capable of detecting transmission errors. The sending and receiving of data for establishing and the discarding of connections via TCP is omitted in FIG. 13.

The data that is sent and received between the mobile device 700 and he STB having storage playback function 100 is sent as IP packets. In the device authentication processing within the home, the STB having storage playback function 100 and the mobile device 700 monitor the TTL (Time To Live) of the received packet, and a packet with set with a TTL whose value exceeds a specified TTL value (for example, TTL=3) is discarded to prevent access from outside the user home 1. The TTL is a value expressing the validity period of the packet and is shown by integers up to a maximum of 255. The TTL is attached to the packet and is decremented by 1 each time it passes through the router, etc.

The mobile device 700 and the STB having storage playback function 100 set a TTL value in the packet for sending below the specified TTL value that is previously described, in order to prevent access from outside the user home 1.

In this sequence, the mobile device 700 first of all creates an authentication request. The device authenticator processor unit 8010 of the mobile device 700 attaches information unique to the device including the above described device ID, and certificate for the information unique to the device to the authentication request and sends it to the STB having the STB having storage playback function 100 by way of the communication processor unit 8017 (S1301).

The device authentication processor unit 7010 for the STB having the STB having storage playback function 100 accepts the authentication request by way of the communication processor unit 7018, and after sending that receiving confirmation to the mobile device 700 (S1302), the device authentication processor unit 7010 for the STB having the STB having storage playback function 100 creates an authentication request from its own side, and the same as for the mobile device 700, attaches unique information for the STB having storage playback function 100 and its certificate to the authentication request, and sends it to the mobile device 700 (S1303).

The device authenticator processor unit 8010 of the mobile device 700 accepts the authentication request, and sends the receiving confirmation to the STB having the STB having storage playback function 100 (S1304).

Next, the device authentication processor unit 7010 for the STB having the STB having storage playback function 100 certifies each information that is received in the authentication request, and sends an authentication reply that the parameter required for generating key information is attached to the mobile device 700 (S1305).

After accepting the authentication reply and sending its receiving confirmation to the STB having the STB having storage playback function 100 (S1306), the device authenticator processor unit 8010 of the mobile device 700 then creates an authentication reply from its own side, and the same as the case with the content transmission device, sends an authentication reply that a parameter required for generating key information is attached to the STB having the STB having storage playback function 100 (S1307), and generates an authentication key in common with the STB having the STB having storage playback function 100, by utilizing required parameters attached to the authentication reply that is received from the STB having the STB having storage playback function 100.

The device authentication processor unit 7010 for the STB having the STB having storage playback function 100, receives the authentication reply and sends its receiving confirmation to the mobile device 700 (S1308), and the same as with the mobile device 700, generates an authentication key in common with the mobile device 700 by utilizing required parameters attached to the authentication reply that is received from the mobile device 700.

In the procedure up to now, a common authentication key is mutually generated and jointly shared for both the device authentication processor unit 7010 for the STB having the STB having storage playback function 100, and the device authenticator processor unit 8010 of the mobile device 700. The processing from here onwards is executed only for the case where the authentication key is jointly shared. If the authentication key is not jointly shared then this device authentication processing is ended.

Next, in order to confirm whether or not the mobile device 700 is the device within the home, the STB having the STB having storage playback function 100 confirms that the mobile device 700 is registered within the in-home device info table 1010, and a value is set in the in home counter value 1023 (the setting of a value into the in home counter value 1023 is described later in S1318). When these results show that the mobile device 700 is not registered in the in-home device info table 1010, or when the value of the in home counter value 1023 is not set or is set to “0”, the message to make in-home confirmation preparation is sent to the mobile device 700 (S1309).

The device authenticator processor unit 8010 of the mobile device 700 receives notification for an in-home confirmation preparation, and when that receiving confirmation is sent to the STB having the STB having storage playback function 100 (S1310), creates an in-home confirmation preparation notification from its own side, and sends it to the STB having the STB having storage playback function 100 (S1311).

The device authentication processor unit 7010 for the STB having the STB having storage playback function 100, receives notification of the in-home confirmation preparation, and when that receiving confirmation is sent to the mobile device 700 (S1312), sends an in-home confirmation setting request attached with information required for an in-home confirmation to the mobile device 700 (S1313).

The device authenticator processor unit 8010 of the mobile device 700 receives the in-home confirmation setting request, performs message authentication code generation processing based on data contained in the in-home confirmation setting request as preparation required for the in-home confirmation, and sends the receiving confirmation to the STB having the STB having storage playback function 100 (S1314).

The device authentication processor unit 7010 for the STB having the STB having storage playback function 100 that received the receiving confirmation, performs message authentication code generation processing based on data that is sent to the mobile device 700 in S1313, and after the timer 1091 starts within the device info manager unit 7009, sends an in-home confirmation execution request including a generated message check code to the mobile device 7 in order to check that the mobile device 700 is within the home (S1315).

The device authenticator processor unit 8010 of the mobile device 700 receives the in-home confirmation execution request, and sends a receiving confirmation including a message authentication code generated in S1314 to the STB having the STB having storage playback function 100 (S1316).

The device authentication processor unit 7010 for the STB having the STB having storage playback function 100 stops the timer 1091 after accepting the receiving confirmation, and confirms that the measurement value (T1) from issuing an in-home confirmation execution request in S1315 until accepting the receiving confirmation in S1316 does not exceed the in-home confirmation timeout value (T) 1921 in the retain in-home confirmation threshold table 1920. The device authentication processor unit 7010 also checks that the message authentication code contained in the receiving confirmation that is received is correct or not.

When the measurement value (T1) is less than or equal to the in-home confirmation timeout value (T) 1921 in the in-home confirmation threshold table 1920, and further when the received message check code is correct, a judgment is made that there is a mobile device 700 within the home, and it is a device within the scope of personal use, and this is sent as the in-home confirmation result to the mobile device 700 (S1317).

However, when the measurement value (T1) is greater than the in-home confirmation timeout value (T) 1921 in the in-home confirmation threshold table 1920 or the received message authentication code is not correct, the mobile device 700 might possibly be outside the home or might be an unauthorized device, and after sending the in-home confirmation result (S1317), the processing in S1309 through S1316 is attempted (retry) again. Then, if a specified number of retries is exceeded, the subsequent processing is stopped and the device authentication processing ends.

The device authenticator processor unit 8010 of the mobile device 700 that accepts the in-home confirmation result, confirms whether or not the message authentication code is correctly received in S1315, and if judged as correct, a receiving confirmation is sent to the STB having storage playback function 100 (S1318).

When judging that there is a mobile device 700 within the home in S1316 and S1317, the device authentication processor unit 7010 for the STB having storage playback function 100 that receives the receiving confirmation, instructs the registration of mobile device 700 in the device info manager unit 7009. The device info manager unit 7009 registers information relating to the mobile device 700 in the in-home device info table 1010 and manages the information (S1319). As shown in the record 1028 of ID 1020 of the in-home device info table 1010 for example, the device info manager unit 7009 sets the device ID of the mobile device 700 that is received in S1301 into the device ID 1021, sets the IP address of the mobile device 700 in the network into the address info 1022, sets the maximum counter value 1004 in the definition table 1000 into the in-home counter value 1023, and sets the status 1024 to “stop.” The in-home counter value 1023 where the counter maximum value 1004 is set, counts down to each specified time or to each specified transmission size during transmission (status 1024 is for example at “access-in-progress) of contents as shown in S1214 in FIG. 12. When the in-home counter value 1023 reaches “0” the countdown stops.

The in-home confirmation method for in-home access for normal authentication is given in S1309 through S1318. The device authentication processor unit 7010 for the STB having the STB having storage playback function 100 here registers the mobile device 700 in the in-home device info table 1010, and the in-home confirmation processing from S1309 through S1318 is omitted when there is a value set in the counter value 1023.

When the message check code that is received in S1316 is incorrect, the process from that point onwards is discontinued, and the device authentication processing ends.

The device authentication processor unit 7010 for the STB having the STB having storage playback function 100 that registers information relating to the mobile device 700 in S1319, generates a replacement key for usage when encrypting its own content for distribution, encrypts the replacement key by utilizing the authentication key, and sends the replacement key along with an ID for identifying the replacement key to the mobile device 700 (S1320). The device authentication processor unit 7010 instructs the key manager unit 7011 to retain and manage the generated replacement key.

The device authenticator processor unit 8010 of the mobile device 700 decrypt the replacement key that was sent from the STB having the STB having storage playback function 100 using the authentication key, and sends a receiving confirmation (S1321). The device authenticator processor unit 8010 then instructs the key manager unit 8011 to retain and manage the generated replacement key.

The device authentication processor unit 7010 for the STB having the STB having storage playback function 100; and the device authenticator processor unit 8010 of the mobile device 700; jointly share the replacement key by way of the process sequence shown in FIG. 13. The replacement key is set along with the incidental information relating to the replacement key in the in-home replacement key 1011 within the in home device info table 1010; and is used to generate a common key for encrypting and decrypting the contents. This setting may be collectively performed respectively with the process of S1309 through S1313, and the process of S1317 through S1319.

### <Device Registration Procedure for Remote Access>

Next, the device registration process that is required in advance by the mobile device 700 brought out of the home (out-of-home destination or a company, etc.) for utilizing contents accumulated in the STB having the STB having storage playback function 100 or TV having storage playback function 200 is described.

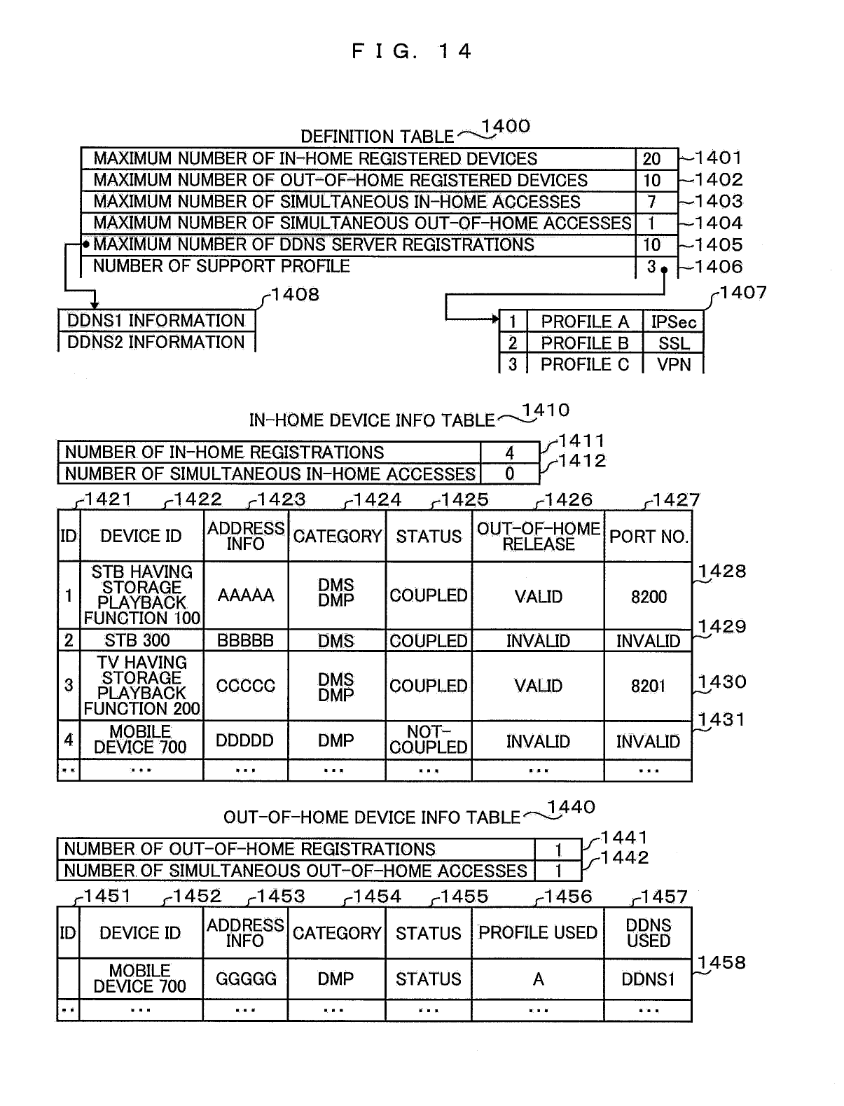

A router 500 capable of remote access is required when the mobile device 700 is accessing devices in an in-home network from outside the home.

Whereupon, a configuration example for device information that is handled by the remote access server unit 9004 of the remote access router 500 is first of all described while referring to FIG. 14. The device information is stored in the memory 501.

The device information includes a definition table 1400, an in-home device info table 1410, and an out-of-home device info table 1440.

The definition table 1400 includes the maximum number of in-home registered devices 1401, the maximum number of out-of-home registered devices 1402, the maximum number of simultaneous in-home accesses 1403, the maximum number of simultaneous out-of-home accesses 1404, the maximum number of DDNS server registrations 1405, and the number of support profiles 1406.

The maximum number of in-home registered devices 1401 shows the maximum number of device within the home capable of being registered, and is set to “20” for example.

The maximum number of out-of-home registered devices 1402 shows the maximum number of devices for out-of-home access that are capable of being registered in the router 500, and is to “10” for example. When the device holds the same value in the maximum number of in-home registered devices 1401 and the maximum number of out-of-home registered devices 1402, then the definition table 1400 may utilize either value.

The maximum number of simultaneous in-home accesses 1403 shows the maximum number of allowable access requests within the home, and is set to “7” for example.

The maximum number of simultaneous out-of-home accesses 1404 shows the maximum number of allowable access requests from outside the home, and is set to “1” for example. When the device holds the same value in the maximum number of simultaneous in-home accesses 1403 and the maximum number of simultaneous out-of-home accesses 1404, then the definition table 1400 may utilize either value.

The maximum number of DDNS server registrations 1405 shows for example the maximum number of DDNS servers 7 capable of being registered in the router 500, and is set to “10” for example. The registration information 1408 relating to the DDNS server 7 registered in the router 500 is retained in the memory 501. The router 500 notifies or sets address information used in the external coupler unit 507, periodically or when there is a change in the address information; for the DDNS server 7 registered by using the DDNS client function.

The number of support profiles 1406 shows the number of support for secure communication protocols (SSL, IPsec, VPN, etc.) utilized for establishing secure communication channels between the remote access communication unit 505 and the remote access communication processer unit 9007 of the router 500 and devices for access from outside the home (for example, mobile device 700). The number of support profiles 1406 is set for example to “3”, and the content of the actual support profile is contained for example in a list as shown in 1407.

The registration information 1408 relating to the DDNS server includes identification information (name and name of company managing the DDNS server) for the DDNS server 7 and URL and user name/password required for access to the DDNS server 7 as needed for each registered DDNS server. The router 500 may provide a setting screen in HTML format to the device over the in-home network 11 by way of the local access communication unit 508, and may receive registration information 1408 relating to the DDNS server from the user, and when the device is coupled over the in-home network 11, the router 500 may receive information relating to the DDNS server pre-stored in that coupled device, and may set it into the registration information 1408.

The in-home device info table 1410 contains: the number of in-home registrations 1411, the number of simultaneous in-home accesses 1412, the ID 1421 as information relating to one device, the device ID 1422, the address info 1423, the category 1424, the status 1425, out-of-home release 1426, and the port number 1427.

The number of in-home registrations 1411 shows the number of devices currently registered in the in-home device info table 1410. When this value reaches the above described maximum number of in-home registered devices 1401, the remote access server unit 9004 does not accept registration requests from then onwards or makes new registrations after deleting an optional registration information.

The number of simultaneous in-home accesses 1412 shows the number of devices that are starting to access the router 500 or are already accessing it. When this value reaches the above described maximum number of simultaneous in-home accesses 1403, access requests from then onwards are not accepted.

The ID 1421 indicates a registration number for registration into the in-home device info table 1410.

The device ID 1422 shows the identifier for uniquely identifying each device.

The device ID 1021 is information unique to a device for automatically generating an optional ID according to a specified algorithm or stored in advance in the non-volatile memory of the memory 110 during manufacture of each device, and contains a value unique to each device.

The address info 1423 shows the IP address (IPv4/IPv6) and MAC address for each device in the in-home network. The IP address may be limited to an address configuration assumed for use at home such as private addresses and local addresses, etc.

The category 1424 shows the device type for each device in the in home network (for example shows the function that the device contained in the device information of the above described device description information provides). In the present embodiment, a media server (DMS) and a media renderer (DMP) are shown as examples of device types.

The status 1425 shows the current connection status of the router 500 with each device, and for example retains values showing the status such as connection, no-connection, or connection in-progress.

The out-of-home release 1426 shows whether or not the router 500 has released information relating to each device to devices accessing the router 500 from outside the home (Out-of-home destination). When this information is “Valid”, the device info service 9002 for the router 500 provides information relating to each device to devices outside the home only when the specified conditions are satisfied. When “Invalid” the device info service 9002 does not provide information relating to each device to devices outside the home. This default value for this setting value is “Invalid.” The port number 1427 shows the number of the communication port for the router 500 as proxy for each device to accept access from devices outside the home, and is utilized only when the setting value is “Valid.” The port number 1427 may be a different number for each device and may even be a number common to each device.

The out-of-home device info table 1440 includes: the number of out-of-home registrations 1441, the number of simultaneous out-of-home accesses 1442, ID 1451 as information relating to one device, the device ID 1452, the address info 1453, the category 1454, the status 1455, the Profile used 1456, and the DDNS used 1457.

The number of out-of-home registrations 1441 shows the number of registrations of devices permitted to remote access the router 500 from outside the home. When this value reaches the above described maximum number of out-of-home registered devices 1402, the remote access server unit 9004 does not accept registration request from then onwards, or makes a new registration after deleting one optional registration information.

The number of simultaneous out-of-home accesses 1442 shows the number of devices outside the home starting to access the router 500 or already accessing it. When this value reaches the above described maximum number of simultaneous out-of-home accesses 1404, the remote access server unit 9004 does not accept access requests from then onwards.

The ID 1451 shows the registration number into the out-of-home device info table 1440.

The device ID 1452 shows the identifier for uniquely identifying each device, and is information identical to the above described device ID 1422.

The address info 1453 shows the IP address (IPv4/IPv6) and MAC address, etc. of each device in the out-of-home network.

The category 1454 shows the device type for each device in the in-home network, and is information identical to the above described category 1424.

The status 1455 shows the current connection status of the router 500 with each device outside the home, and for example retains values showing the status such as connection, no-connection, or connection in-progress.

The profile used 1456 shows the method that is utilized in establishing a secure communication path established between each device outside the home and the router 500, and is equivalent to any of the above described support profile contents.

The DDNS used 1457 shows information relating to the DDNS server 7 utilized for acquiring address information for the router 500 in order for the out-of-home device to access devices on the in-home network by way of the router 500. The DDNS used 1457 shows for example address information and registration information (device name, user name/password, etc.) that are required for notifying/setting the DDNS server 7 of address information that the router 500 uses in the external coupler unit 507.

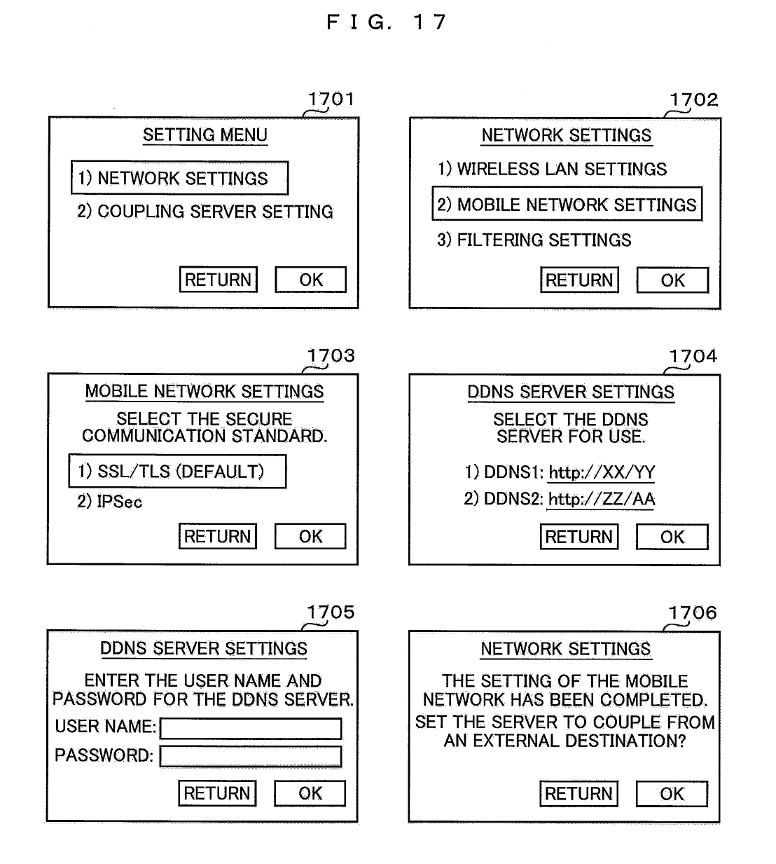

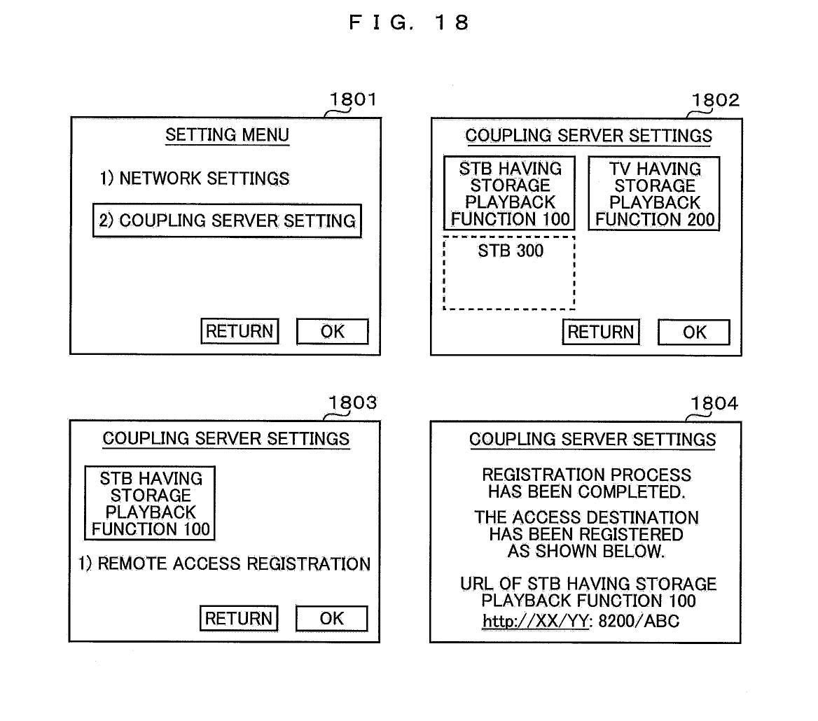

The registration process required for execution beforehand in order to access to a device (STB having storage playback function 100, etc.) within the home or the router 500 from a device brought to outside the home is described next utilizing FIG. 15, FIG. 17, and FIG. 18.

The procedure in the present embodiment for registering the mobile device 700 in the STB having storage playback function 100 and the router 500 is described based on the user operation of the mobile device 700. Here, prior to the start of the procedure, the mobile device 700 acquires in advance address information utilized in the wireless access point unit 511 and the local access communication processor unit 9008 for the router 500 and the name or the identifier for uniquely identifying the router 500.

When the user starts the setting application 8020 according to operation of the operating IF unit 712 of the mobile device 700, the setting application 8020 displays for example a screen 1701 in the display unit 707. A “Network setting” menu for making network environmental settings on the mobile device 700 and a “Coupling server setting” menu for selecting a server to acquire each type of data and content are displayed on the screen 1701.

The setting application 8020 displays for example the screen 1702 when the user selects the “Network setting” menu on the displayed screen 1701. The screen 1702 displays network setting types such as a “Wireless LAN setting” menu for setting information relating to wireless communication in the communication processor unit 8017 and the wireless communication unit 708 and a “Mobile network setting” menu for setting information relating to remote access communication from outside the home for the remote access discovery agent unit 8014, the remote access client unit 8015, the remote access transport agent unit 8016, the communication processor unit 8017. When accepting the selection of the “Mobile network setting” menu on the screen 1702 by user operation, the setting application 8020 sends a “WAN side IP address acquisition request” message for acquiring address information utilized in the external coupler unit 507 to the router 500 by way of the communication processor unit 8017 and wireless communication unit 708.

The remote access server unit 9004 of the router 500 that receives the “WAN side IP address acquisition request” message by way of the local access communication unit 508 (in this case, the wireless access point unit 511) and the local access communication processor unit 9008, utilizes technology such as the STUN client function to acquire WAN side IP address information assigned to the remote access communication unit 505 from the communication service provider 5, and notifies the mobile device 700. When the WAN side IP address is not acquired, the remote access server unit 9004 send back that fact to the mobile device 700 (S1501).

The setting application 8020 for the mobile device 700 that acquired the WAN side IP address, decides if the environment allows network communication between inside the home and outside the home by way of the router 500, and sends a “DDNS setting information acquisition request” message for acquiring information relating to the DDNS server 7 that is registered in the router 500, to the router 500. When the WAN side IP address cannot be acquired from the router 500, the setting application 8020 display a “Cannot connect to Internet” message on the display unit 707, and notifies the user.

The remote access server unit 9004 for the router 500 that receives the “DDNS setting information acquisition request” message, notifies the mobile device 700 of the registration info 1408 relating to the DDNS service server 7. When there is no DDNS server 7 registered in the device information for the router 500, the remote access server unit 9004 for the router 500 returns that fact to the mobile device 700 (S1502).

When the setting application 8020 for the mobile device 700 receives the fact that there is no DDNS server 7 registered in the router 500, a warning screen with the fact that for example, “New registration of a DDNS server is required” is displayed on the display unit 707, and this registration process is stopped or a shift is made to a new registration process for DDNS service.

However, when the mobile device 700 receives the registration info 1408 or namely, there is one or more DDNS servers 7 registered in the router 500, a “remote access secure standard acquisition request” message for acquiring a protocol to support the router 500 establishing a secure communication path with devices outside the home is sent to the router 500.

The remote access server unit 9004 for the router 500 that acquired the “remote access secure standard acquisition request” message, notifies the mobile device 700 with the support profile info 1407 registered in the device information by utilizing the coupler setting info management service 9006 (S1503).

The setting application 8020 for the mobile device 700 that receives the support profile info 1407 from the router 500, utilizes the coupling setting info processing unit 8018 of the remote access client unit 8015 to check whether or not there is a selection applicable to the profile information 1104, 1105 contained in its own device information 1100 in the support profile info 1407. When results of the check are that there is nothing applicable, the setting application 8020, displays a warning screen on the display unit 707 showing, “This communication protocol is not supported. Please download the required software.” and discontinues this registration procedure or shift to processing for downloading software for achieving a secure method.

However, when one or more methods are applicable, the setting application 8020 for the mobile device 700 displays for example screen 1703 on the display unit 707, urging the user to select a secure communication method for usage, and accepts the selection of a secure communication method. Besides accepting a secure communication method that the user selects, the setting application 8020 may automatically select a secure communication method based on an optional standard (for example, a previously registered communication method, a high usage frequency and high security level, and installed with the latest software, etc.).

Next, the setting application 8020 for the mobile device 700 displays information relating to the DDNS server 7 acquired in S1502 as for example in screen 1704 as a selection on the display unit 707, urges the user to select the DDNS server 7 for usage, and accepts the selection of the DDNS server 7. Here, Besides accepting the DDNS server 7 selected based on instructions from the user, the setting application 8020 may select the DDNS server 7 based on an optional standard (for example, a previously registered DDNS server information, a high usage frequency, installed with the latest software, etc.). When the setting application 8020 for the mobile device 700 accepts the selection of the DDNS server 7 made by a user instruction, a screen 1705 for example is displayed on the display unit 707, and the user name and password input by the user are accepted by way of the operating IF unit 172 that are required when the accessing the DDNS server 7 selected by the router 500 or the mobile device 700. When the mobile device 700 already retains the user name and password, the setting application 8020 need not display the screen 1705. (S1504)

The setting application 8020 for the mobile device 700 next sends the “remote access secure standard setting request” message containing the secure communication method selected in S1504 to the router 500.

The remote access server unit 9004 for the router 500 that receives the “remote access secure standard setting request” message, utilizes the coupler setting info management service 9006 to register the information 1458 relating to the mobile device 700 in the out-of-home device info table 1440, and sets the device ID 1452 and the profile name of the secure communication standard or method contained in this message into the profile 1456. The remote access server unit 9004 then replies to the mobile device 700 on whether or not the Profile used 1456 is set.

The setting application 8020 for the mobile device 700 that receives the setting results, newly adds the ID 1120 of the device info table 1110 by using the coupling setting info processing unit 8018 of the remote access client unit 8015, sets the identifier that uniquely identifies the name of the router 500 in the router ID 1121, sets the IP address of the WAN side acquired in S1501 and if necessary the IP address used inside the home into the address info 1122, and sets a “YES” in the remote access server function available 1123, and sets the profile information for the secure communication standard selected in S1504 into the profile used 1124 (S1505).

The setting application 8020 for the mobile device 700 next sends a “DDNS information setting request” message containing a user name/password, URL and identification information for the DDNS server 7 selected in S1504 to the router 500.

The remote access server unit 9004 for the router 500 that receives the “DDNS information setting request” message, sets all of the information contained in this message or only the portion required such as the URL and identification information to the DDNS used 1457 of the info 1458 relating to the mobile device 700 of the out-of-home device info table 1440. A message that informs whether or not the setting is made is sent back to the mobile device 700.

The setting application 8020 for the mobile device 700 that receives the setting result utilizes the remote access client unit 8015 to set the information (URL or user name/password, etc.) for accessing the DDNS server 7 when remotely accessing a device within the home or the router 500 from outside the home, into the DDNS server info 1125. The setting application 8020 for the mobile device 700 then displays for example a screen 1706 on the display unit 707, notifies the user that the required network settings are complete, and next urges a shift from outside the home to the remote access destination. (S1506)

The setting application 8020 for the mobile device 700 next displays for example the screen 1801 on the display unit 707 shown in FIG. 18, and shifts to “Setting process for information relating to in-home devices” required for the mobile device 700 brought to an out-of-home destination to access the contents held in an in-home device. First of all, the setting application 8020 for the mobile device 700 sends an “Acquire device information relating to the in-home network” message to the router 500 in order to acquire information relating to devices permitted a remote access function with devices on the in-home network.

The remote access server unit 9004 for the router 500 that receives the Acquire device information relating to the in-home network” message utilizes the filter setting service 9005 to extract device information whose setting value for the out-of-home release 1426 is “Valid” from among device information registered in the in-home device info table 1410, and sends those extracted contents back to the mobile device 700.

The setting application 8020 for the mobile device 700 that acquires device information within the home capable of providing its own retained contents to the access devices from outside the home, displays for example a screen 1802 on the display unit 707, urges the user to select an in-home device for access from outside the home, and accepts the selection. Here, when an in-home device capable of providing copyright-protected contents (not registered in the router 500) to outside the home is found when searching for devices within the home by the above described procedure in S1201 through S1206 in FIG. 12, that information may also be displayed on the screen 1802, not only for device information acquired from the router 500.

The remote access server unit 9004 for the router 500 may send back information relating to devices not permitted a remote access function (for example, information for the STB300), to the mobile device 700. Also, the setting application 8020 for the mobile device 700 may also display “not permitted” as information relating to devices not permitted a remote access function on the screen 1802 by a display method understandable by the user (S1507).

When the user selection of an in-home device for remote access is accepted on the screen 1802, the setting application 8020 for the mobile device 700 for example displays the screen 1803, and after accepting reconfirmation of the device (in this case the STB having storage playback function 100) selected by the user, instructs the device authenticator processor unit 8010 to execute the remote access device registration processing with the device authentication processor unit 7010 of the STB having storage playback function 100. This remote access device registration processing is described later on in detail in FIG. 16 (S1508).

When the remote access device registration processing for the STB having storage playback function 100 is a failure, the setting application 8020 for the mobile device 700 notifies the user of that failure on a warning screen, discontinues this device registration processing, or returns to screen 1801 and accepts another in-home device selection from the user.

However, when the remote access device registration process is successful, the device info service 7008 of the STB having storage playback function 100 sends a “device information acquisition request” message to the router 500 after checking that there is a mobile device 700 registered in the out-of-home device info table 1030 by utilizing the device info manager unit 7009.

The remote access server unit 9004 of the router 500 that receives the “device information acquisition request” message sends all or a portion of the information registered in the in-home device info table 1410, and all or a portion of the information registered in the out-of-home device info table 1440 into the STB having storage playback function 100 (S1509).

The device info service 7008 for the STB having storage playback function 100 that receives the device information registered in the router 500, confirms whether or not its own device is already registered in the router 500 registration information. When already registered, the device info service 7008 checks the setting value in the out-of-home release 1426. A check may also be made on whether or not the mobile device 700 is already registered in the router 500 (S1510).

Then, when its own device information is not contained in the router 500 registration information, or even if already registered, the setting value for the out-of-home release 1426 is “Invalid”, the device info service 7008 edits the received registration contents or creates the update request contents and then sends a “Display filter information update request” message containing those contents to the router 500. Here, no action need be taken if there were no corrections or additions to the registration contents

The remote access server unit 9004 of the router 500 that receives the “Display filter information update request” message utilizes the filter setting service 9005 to add or update the registration contents of the in-home device information table 1410 as needed (S1511).

However, when the remote access device registration process S1508 is successful, the mobile device 700 sends a “Display filter information acquisition request” message to the router 500 for acquiring the registration contents of the in-home device info table 1410 of the router 500.

The remote access server unit 9004 of the router 500 that receives the “Display filter information acquisition request” message utilizes the filter setting service 9005 to send the contents of in-home device info table 1410 to the mobile device 700.

The setting application 8020 for the mobile device 700 that receives the contents of in-home device info table 1410 of router 500, confirms whether or not information for the STB having storage playback function 100 is registered, and when a setting value of “Valid” is also confirmed for the out-of-home release 1426, displays for example the screen 1804 on the display 707 and notifies the user that this registration process is completed.

Here, when the information for the STB having storage playback function 100 is not registered or the out-of-home release 1426 setting value is set to “Invalid”, the setting application for the mobile device 700 may immediately or after an optional amount of time elapses resend a “Display filter info acquisition request” message to the router 500. When the desired result is not obtained even executing an optional number of retries, then a warning display notifying of the failure of this registration processing is displayed, and this registration process is stopped or the process returns to the screen 1802 (S1512).

In the above registration processing, the user can execute the required registration processing for permitting remote access to the router 500 and the in-home device by utilizing the setting application 8020 of the mobile device 700.

Here, the above described S1502 and S1503, or the S1505 and S1506 may be collectively employed in one process, and the S1502 and S1503 performed in a reverse of the procedure or the S1505 and S1506 performed in a reverse of the procedure.

Also, the secure communication standard/method or the DDNS server utilized by the mobile device 700 are selected in S1504, however, a method may also be utilized that sends contents supported by the mobile device included in the “DDNS setting info acquisition request” message in S1502, and the “Remote access secure standard acquisition request” message in S1503, and that is suitable for confirming the router 500's own registration contents and the support content of the mobile device 700.

Also in S1507, the setting application 8020 for the mobile device 700 sends a “Device info acquisition relating to in-home network” message, but here however, displays the device searched or detected by itself on the screen 1802. The setting application 8020 may then send a “Device info acquisition relating to in-home network” message instead of the “Device filter info acquisition” message in S1512 or either prior to or after S1512.

The remote access server unit 9004 of the STB having storage playback function 100 does not send a “Device info acquisition request” message in S1509, and may execute the processes in S1510 and S1511.

The remote access device registration process S1508 may even be executed prior to S1501 and may be executed after S1501. In this case, the S1509 through S1511 executed by the remote access server 9004 for the STB having storage playback function 100 can be executed in parallel with the S1502 through S1507 executed by the setting application 8020 of the mobile device 700.

The details of the remote access device registration process S1508 executed between the STB having storage playback function 100 and the above described mobile device 700 are described next using FIG. 16. In the procedure implemented here, the mobile device 700 is inside the user home 1. Also, the mobile device 700 and the STB having storage playback function 100 monitor the TTL of the packets received during this procedure, and packets whose set TTL value exceeds a specified value are discarded to prevent executing a procedure from outside the user home 1. The mobile device 700 and the STB having storage playback function 100 therefore always set the TTL of their own packets for sending, to lower than a specified value.

The mobile device 700 and the STB having storage playback function 100 first of all implement the device authentication process S1212 described in FIG. 13.

After the process S1212, the device authenticator processor unit 8010 of the mobile device 700 creates an “Out-of-home access device registration request” and sends it to the STB having storage playback function 100 (S1601). The out-of-home access device registration request can also include a random number generated by utilizing a specified processing algorithm and information unique to the device, and a password that is set for user access from outside the home.

The device authentication processor unit 7010 for the STB having storage playback function 100 accepts the out-of-home access device registration request, and in S1602 decides whether or not the mobile device 700 is already registered in the out-of-home device info table 1030 by for example using the device ID 1041 or the address info 1042. When the mobile device 700 is already registered, the device authentication processor unit 7010 sends back a receiving confirmation containing the status showing registration is a success or registration is already complete and the processing shifts to S1604.

When the mobile device 700 is not registered, the device authentication processor unit 7010 searches the number of out-of-home registrations 1031 within the out-of-home device info table 1030 and decides whether or not the number of devices registered for out-of-home remote access is below the maximum number of out-of-home registered devices 1003 in the definition table 1000. Then, if the number of device registered for out-of-home access reaches the maximum number, the device authentication processor unit 7010 discontinues the registration processing and sends a receiving confirmation containing the status showing registration is impossible or is the maximum number to the mobile device 700.

However, when the number of device registered for out-of-home access does not yet reach the maximum number, then after a check for a match with device ID for the mobile device 700 accepted in the S1301/S1601, a receiving confirmation including the result for whether or not the mobile device 700 is registered as a device capable of remote access in the out-of-home device info table, is sent to the mobile device 700 (S1603). The device authentication processor unit 7010 then sets identification information for the mobile device 700 into the device ID 1041 within the out-of-home device info table 1030, sets the MAC address and IP address of the mobile device 700 into the address info 1042 over the network, sets a “Stop” in the transmission status 1044, and sets the maximum counter value within the definition table 1000 into the out-of-home counter value 1045 (S1604).

The device authenticator processor unit 8010 of the mobile device 700 that receives the receiving confirmation from the device authentication processor unit 7010 for the STB having storage playback function 100 searches the registration results contained in the receiving confirmation, and when the status shown registration result is successful or registration is completed, the contents of the device info table 1110 stored in the device info manager unit 8009 are updated (S1605).

In the above processing, the device authentication processor unit 7010 for the STB having storage playback function 100 and the device authenticator processor unit 8010 of the mobile device 700 perform the registration process treating the device as an out-of-home access device, only for devices where the device authentication is a success.

### <Coupling Processing by Remote Access>

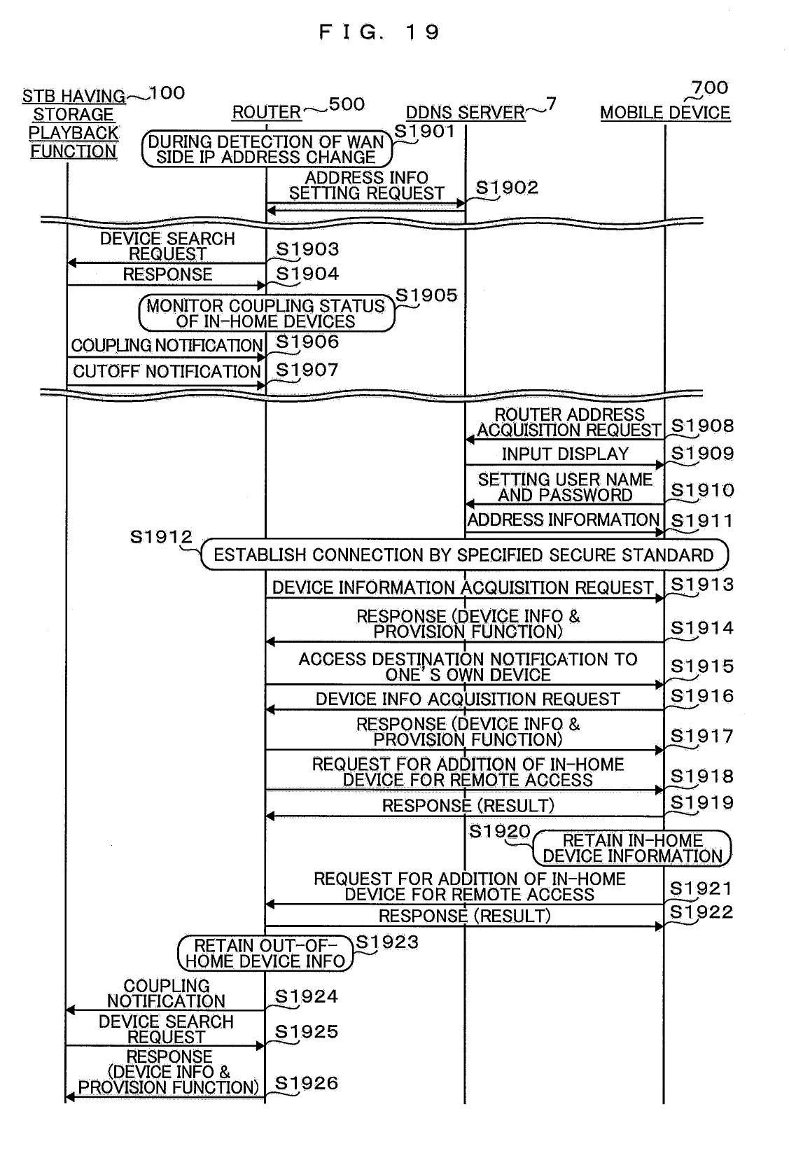

When the device registration processing for remote accessing is a success, the user brings the mobile device 700 out of the home and can access the in-home devices from outside the home.

Whereupon, the communication procedure for accessing the router 500 from the mobile device 700 brought out from the out-of-home destination 2 is first of all described utilizing FIG. 19.

When the remote access server unit 9004 for the router 500 detects a change in the WAN12 side IP address assigned from the communication service provider 5 and that is utilized by the local access communication processor unit 9008 (S1901), the remote access server unit 9004 searches the information relating to the DDNS servers 7 registered in the device information, and sends an “Address info setting request” to these DDNS servers 7, and updates the WAN side IP addresses with the latest information (S1902).

The remote access discovery agent unit 9001 or the remote access server unit 9004 for the router 500 sends a “Device search request” message periodically or at an optional timing as described in S1201 of FIG. 12 over the in-home network (S1903); when a reply is received from the device on the in-home network (S1904) the status 1425 of the in-home device info table 1410 within its own self-managed device information is updated as needed; and the coupling status of the device within the home is constantly monitored (S1905). Further, when the device on the in-home network is itself coupled to the in-home network, a “Coupling notification” is broadcast to all devices on the in-home network (S1906), and when cut off from the in-home network, a “Cutoff notification” is broadcast to all devices on the in-home network (S1907), and the router 500 is set to constantly maintain the latest connection status. When the remote access discovery agent unit 9001 or the remote access server unit 9004 for the router 500 receives a “Coupling notification” from the devices in the in-home network, the status 1425 of the in-home device info table 1410 is set to “Connect”, and when a “Cutoff notification” is received from the devices in the in-home network, the status 1425 of the in-home device info table 1410 is set to “Disconnect.”

When the user who brought the mobile device 700 to the out-of-home destination 2 while in this status, accesses a device within the home, the user starts the content viewing application 8019 when the operating IF unit 712 accepts an operation from the user. When the content viewing application 8020 accepts a selection of in-home device (in this embodiment, the STB having storage playback function 100) for viewing of contents displayed on the display unit 707, the content viewing application 8019 uses the device info table 1110 managed by the coupling setting info manager unit 8018 of the remote access client unit 8015 to send an address information acquisition request for the router 500 to the DDNS server registered in the DDNS server info 1125 (S1908).

In response to this request, the DDNS server 7 sends an entry screen for entry of the user name and password to the mobile device 700 for deciding whether or not sending the address for the router 500 is allowable (S1909).

The content viewing application 8019 for the mobile device 700 displays the received entry screen on the display unit 707 and accepts the entry of the specified user name and password from the user or sets the user name and password registered in the remote access client unit 8015 of the mobile device 700, and sends it to the DDNS server 7 (S1910).

The DDNS server 7 that receives the user name and password, decides whether the entered values are correct or not and then sends address information relating to the router 500 to the mobile device 700 (S1911).

The content viewing application 8019 for the mobile device 700 that acquires the address information which is the access destination of the router 500 instructs the remote access transport agent unit 8016 to establish a secure communication path with the remote access transport agent unit 9003 for the router 500 in conformance with the secure communication method (in this embodiment, the SSL standard) set in the profile used 1124 of the device info table 1110 (S1912).

When a secure communication path with the router 500 is achieved in S1912, the remote access transport agent unit 8016 for the mobile device 700 notifies the remote access discovery agent unit 8014 of this fact.

A virtual network interface coupled to the router 500 is generated in the communication processor unit 8017. Accesses from here onwards are made by way of this virtual network interface when each of functions within the mobile device 700 are accessing the devices in the user home 1.

The remote access transport agent unit 9003 for the router 500 notifies the remote access discovery agent unit 9001 that a secure communication path is established with the mobile device 700.

Next, the remote access discovery agent unit 9001 for the router 500 sends a “Device information acquisition request” message to the remote access discovery agent unit 8014 (S1913).

The remote access discovery agent unit 8014 for the mobile device 700 that receives the “Device information acquisition request” message sends a reply containing functions that are available and its own device information managed in the device info manager unit 8009 and device info service 8008 (S1914).

The remote access discovery agent unit 9001 for the router 500 that receives this reply confirms whether or not the information 1458 relating to the mobile device 700 is registered within the out-of-home device info table 1440. When not registered, the remote access discovery agent unit 9001 stops this connection processing. When registered, the remote access discovery agent unit 9001 sets the status 1455 to “Connection” or “Connection-in-progress”, and next sends device information for the router 500 itself for acquiring the access destination (such as a URL) to the mobile device 700 (S1915).

The remote access discovery agent unit 8014 for the mobile device 700 that acquired the access destination for acquiring device information for the router 500, sends a “Device information acquisition request” message to the router 500 (S1916) by utilizing that access destination.

The remote access discovery agent unit 9001 for the router 500 that receives the “Device information acquisition request” message sends a reply containing functions that are available and its own device information managed by the remote access transport agent unit 9002 to the mobile device 700 (S1917).

After sending the reply, the remote access discovery agent unit 9001 for the router 500 acquires the in-home device info table 1410 managed by the remote access server unit 9004, and sends information relating to the device where a “Valid” is set in the out-of-home release 1426 from among device current connected to the in-home network to the mobile device 700 (S1918).

The remote access discovery agent unit 8014 for the mobile device 700 that acquires information on devices capable of being accessed and currently connected on the in-home network, retains this information, and decides whether or not the STB having storage playback function 100 selected by the user in S1908 is included (in this information) (S1920).

When there is no STB having storage playback function 100 currently connected on the in-home network, the remote access discovery agent unit 9001 for the mobile device 700 notifies the viewing application 8019 of that fact. The viewing application 8019 displays the information that the STB having storage playback function 100 cannot currently be utilized on the display unit 707 and notifies the user. However when decided that a STB having storage playback function 100 is currently connected, the remote access discovery agent unit 8014 for the mobile device 700 requests the remote access discovery agent unit 9001 for the router 500 to notify a device on the in-home network that its own device is connected (S1921).

In response to the above, the remote access discovery agent unit 9001 for the router 500, replies to the mobile device 700 (S1922), and then sets the status 1455 of the out-of-home device info table 1440 to “Connected” and retains information relating to the device connected on the out-of-home network (S1923).

After the above, the remote access discovery agent unit 9001 for the router 500 acting as proxy for the mobile device 700 next broadcasts a “Connection notification” for the mobile device 700 to all devices connected on the in-home network (S1924).

Devices on the in-home network that receives the “Connection notification” broadcast a “Device search request” message to all devices on the in-home network (S1925).

The remote access discovery agent unit 9001 for the router 500 that receives the “Device search request” acting as proxy for the mobile device 700, sends a reply containing functions that are available and device information relating to the mobile device 700 acquired in S1914, to the device that issued the “Device search request” message (S1926).

The mobile device 700 can establish a secure communication path with the router 500 by using the above procedure, and can acquire information on devices current connected on the in-home network. The mobile device 700 can also make devices on the in-home network recognize that it is connected.

### <Content Viewing Process by Remote Access>

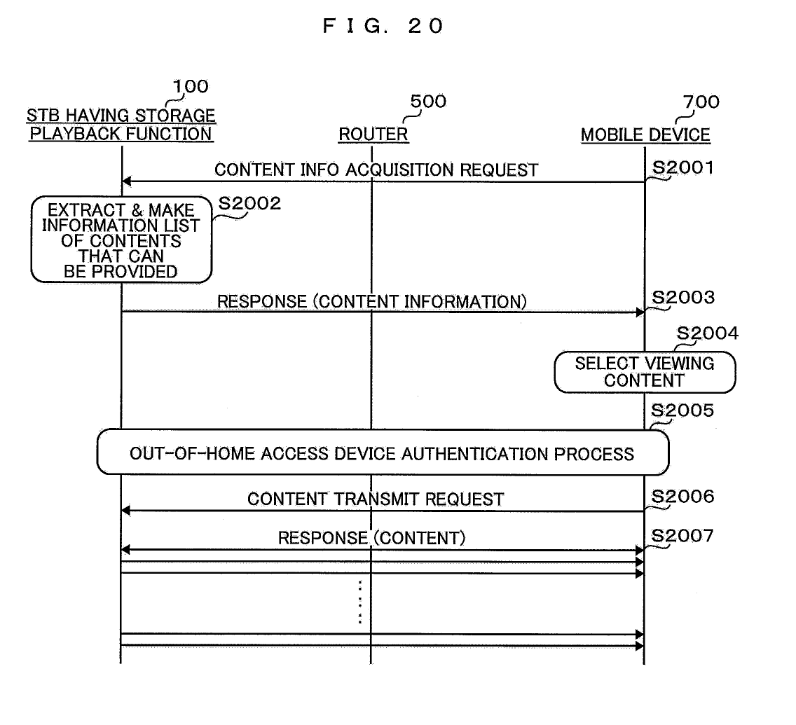

Next, the procedure for viewing the contents capable of being provided by the STB having storage playback function 100 on the mobile device 700, is described using FIG. 20.

The content viewing application 8019 for the mobile device 700 that received the information on devices currently connected over the in-home network in S1918 sends a “Content info acquisition request” message to the STB having storage playback function 100 (S2001).

The content directory service 7007 for the STB having storage playback function 100 that received the “Content info acquisition request” message, acquires content information by using the contents info provider unit 7006, extracts content information capable of being distributed from these contents to outside the home, generates list information (S2002), and sends back a reply containing this information to the mobile device 700 (S2003). Contents that cannot be distributed outside the home are listed here as contents with viewing restrictions or programs currently being received on the tuner 101 (live content) or IP broadcasts being received on the communication unit 108. However, information relating to this content can be provided when the content providers 3, 4, 21, 22 are permitted. Copyright-protected contents being received from other devices (for example, the TV having storage playback function 200, and the STB 300) connected to an in-home network by way of the communication unit 108 cannot be distributed outside the home.

The content viewing application 8019 for the mobile device 700 that acquires viewable content information displays for example the screen 2310 in FIG. 23 on the display unit 707. The user instructs the desired content from among these contents by way of the operating IF unit 712 (S2004). Compared to the screen 2300, in the present embodiment, the screen 2310 utilized in viewing content by remote access from the mobile device 700 does not display programs 1, 2 (live contents) viewed in real time or content 2 with viewing restrictions as selection items.

When the user selects the desired contents, the content viewing application 8019 for the mobile device 700 instructs the device authenticator processor unit 8010 to execute out-of-home access device authentication processing with the STB having storage playback function 100 (S2005).

When the out-of-home access authentication processing succeeds in S2005, the content viewing application 8019 for the mobile device 700 instructs the media receiving controller 8007 to start receiving the contents. The media receiving controller 8007 sends a “Content send request” message to the STB having storage playback function 100 (S2006).

When the media distribution service 7015 for the STB having storage playback function 100 that receives the “Content send request” message, generates a content key based on the replacement key shared in S2005 by using the contents manager unit 7005 and the key generator unit 7012, and uses the encryption processor 7013 to send the contents to the mobile device 700 while encrypting them with the content key (S2007).

The media receiving controller 8007 or the content viewing application 8019 for the mobile device 700 that receives the encrypted contents by way of the communication processor unit 8017, instructs the decryption processor 8013 and the key generator unit 8012, and generates the content key based on the replacement key shared in S2005, and decrypts the contents by using this content key in the decryption processor 8013. After decrypting the content, the demax unit 701 separates the decrypted content into the audio data and the video data, and decodes the audio data in the voice decoder unit 702 and outputs the decoded audio data to the voice output unit 706; and decodes the video data in the video decoder unit 703 and outputs the decoded video data to the display unit 707.

The STB having storage playback function 100 allows the mobile device 700 for remote access to provide its own stored contents only for the purpose of viewing or moving the contents, and may also prohibit copying the contents via remote access.

Here, simultaneous with sending the contents to the mobile device 700 for remote access, the STB having storage playback function 100 allows other devices within the user home 1 (for example, the STB300) to provide their own contents.

The mobile device 700 for remote access prohibits the sending (transfer) of the contents to other devices by way of the wideband wireless communication unit 720 while viewing the contents that are received from the STB having storage playback function 100. However, the device authenticator processor unit 8010 for the mobile device 700 executes the above described device authentication process S1212 shown in FIG. 13, with other devices by way of the wireless communication unit 708, and is capable of sending the contents to other devices by way of the wireless communication unit 708 only in the case that authentication is a success.

FIG. 21 is a drawing showing the device authentication process sequence for out-of-home access and that is executed between the STB having storage playback function 100 and the mobile device 700 in S2005 in order to view the copyright-protected contents accumulated in the STB having storage playback function 100 for viewing on the mobile device 700 outside the home. The STB having storage playback function 100 and the mobile device 700 do not monitor the TTL of the packet being received.

The device authenticator processor unit 8010 for the mobile device 700 generates an out-of-home authentication request, adds unique device information including the above described device ID, and a certificate for the information unique to the device, and sends it by way of the communication processor unit 8017 to the STB having storage playback function 100 (S2101).

When the device authentication processor unit 7010 for the STB having storage playback function 100 receives the out-of-home authentication request, it sends the receiving confirmation for the out-of-home authentication request to the mobile device 700 (S2102).

Next, the device authentication processor unit 7010 for the STB having storage playback function 100 creates an out-of-home authentication request from its own side, adds unique information for the STB having storage playback function and a certificate for the information unique to the device the same as the case with the mobile device 700, and sends it by way of the communication processor unit 7018 to the mobile device 700 (S2103).

The device authenticator processor unit 8010 for the mobile device 700 receives the out-of-home authentication request, and sends that receiving confirmation to the STB having storage playback function 100 (S2104).

Next, the device authentication processor unit 7010 for the STB having storage playback function 100 verifies each information received in the out-of-home authentication request, and sends an out-of-home authentication reply attached with the required parameters needed to generate the key information to the mobile device 700 (S2105).

After receiving the out-of-home authentication reply and sending its receiving confirmation to the STB having storage playback function 100 (S2106), the device authenticator processor unit 8010 for the STB having storage playback function 100 creates an out-of-home authentication reply from its own side, and just the same as the case with the STB having storage playback function 100, sends an out-of-home authentication reply attached with the required parameters needed to generate the key information to the STB having storage playback function 100 (S2107), and utilizes the parameters required for the received out-of-home authentication reply to generate an out-of-home authentication key shared with the STB having storage playback function 100.

The device authentication processor unit 7010 for the STB having storage playback function 100 receives the out-of-home authentication reply, sends its receiving confirmation to the mobile device 700, and just the same as the case with the mobile device 700, utilizes the required parameters attached to the received out-of-home authentication reply to generate an authentication key shared with the mobile device 700 (S2108).

In the procedure up to now, an authentication key is generated in the device authentication processor unit 7010 for the STB having storage playback function 100 and the device authenticator processor unit 8010 for the mobile device 700 and mutually shared.

Next, the device authentication processor unit 7010 for the STB having storage playback function 100 confirms that the device ID for the mobile device 700 is registered within the out-of-home device info table 1030 managed within the device info manager unit 7009. Then, when there is a device ID registered within the mobile device 700, a check is made on whether or not the out-of-home replacement key 1043 is set in the out-of-home device info table 1030. When the out-of-home replacement key 1043 for the mobile device 700 is not set, a check is made on the value in the number of simultaneous out-of-home accesses 1032 of the out-of-home device info table 1030 is smaller than the value for the maximum number of simultaneous out-of-home accesses 1006 in the definition table 1000. Then, when the value in the number of simultaneous out-of-home accesses 1032 is smaller than the value of the maximum number of simultaneous out-of-home accesses 1006, the device authentication processor unit 7010 for the STB having storage playback function 100 adds 1 to the value of the number of simultaneous out-of-home accesses 1032 for the out-of-home device info table 1030, and generates an out-of-home replacement key for use when encrypting the contents to send to its own mobile device 700. The out-of-home replacement key is set as the out-of-home replacement key 1043 of the out-of-home device info table 1030 (S2109). Here, if no device ID for the mobile device 700 is registered in the out-of-home device info table 1030, or if the value in the number of simultaneous out-of-home accesses 1032 for the out-of-home device info table 1030 is the same value or the value lager than the maximum number of simultaneous out-of-home accesses 1006 in the definition table 1000, this device authentication process for out-of-home access is discontinued.

The device authentication processor unit 7010 for the STB having storage playback function 100 that set the generated out-of-home replacement key in the out-of-home device info table 1030, utilizes the authentication key to encrypt the out-of-home replacement key generated in S2109, and sends it along with the ID for identifying the out-of-home replacement key to the mobile device 700 (S2110). After sending, the device authentication processor unit 7010 instructs the key manager unit 7011 about the retention and management of the generated out-of-home replacement key.

The device authenticator processor unit 8010 for the mobile device 700 decrypts the out-of-home replacement key sent from the STB having storage playback function 100 by utilizing the authentication key and sends that receiving confirmation (S2111). The device authenticator processor unit 8010 then instructs the key manager unit 8011 about the retention and management of the generated replacement key.

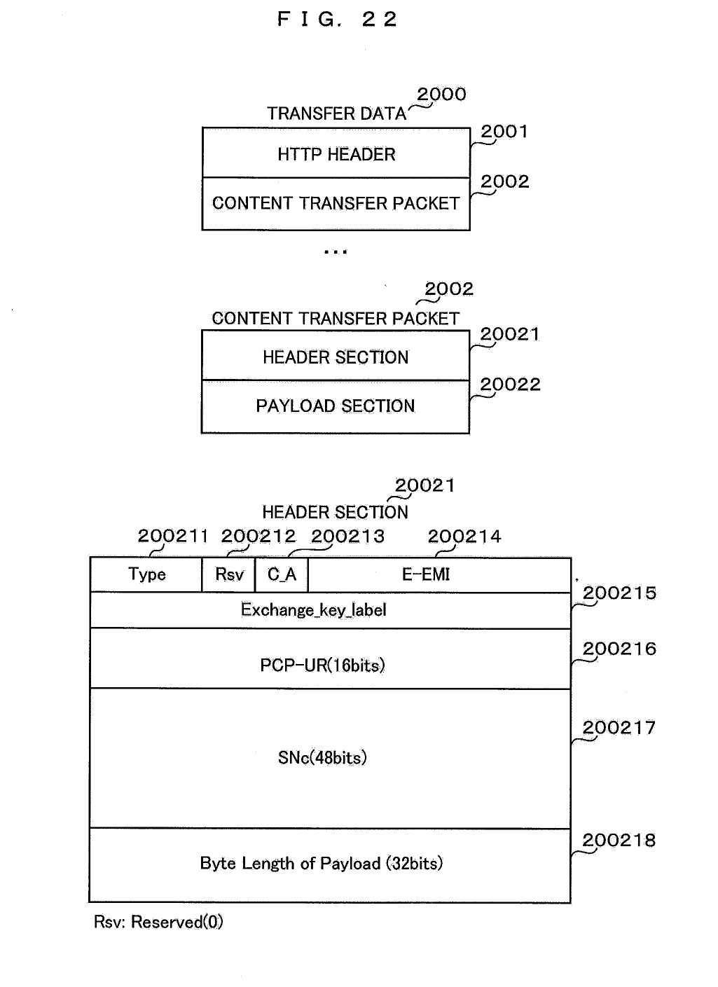

FIG. 22 shows an example of data when sending contents by utilizing an HTTP protocol in the above described S2007. Here, TCP is utilized as the transport layer protocol however the TCP header may be omitted.

The transmission data 2000 that is utilized when sending contents by utilizing an HTTP protocol is configured from an HTTP header 2001, and a content transfer packet 2002.

The content transfer packet 2002 is configured from the header unit 20021 and the payload unit 20022.

The header section 20021 is comprised of a Type 200211, a Reserved (reserved region) 200212, a CA (encryption method) 200213, an E-EMI (encryption mode) 200214, an Exchange_Key_Label (replacement key label) 200215, a PCP-UR (copy limit information) 200216, a SNc (random number value) 200217, and a Byte Length of Payload (payload size) 200218.

The Type 200211 holds a fixed value for identifying the type of content transfer packet 2002.

The Reserved (reserved region) 200212 is a reserved region and is set to 0. The C_A (encryption method) 200213 indicates the encryption method for the payload section, and for example specifies AES encryption standard with a 128 bit key.

The E-EMI (encryption mode) 200214 indicates the encryption mode for the payload section, and is utilized along with the PCP-UR (copy limit information) 200216 and the SNc (random number value) 200217 to calculate the content key.

A label to specify the key that is replaced in the authentication procedure for the 600 is set in the Exchange_Key_Label (replacement key) 200215.

The PCP-UR (copy limit information) 200216 indicates the copy control information for the payload section, and includes a UR mode which is a copy control mode expressing the type of copy control information, a Content Type expressing the type of payload section, an APS for limiting the analog output, and an ICT for limiting the resolution, etc.

The size of the payload section 1702 for the content transfer packet 1702 is set in the Byte Length of Content (payload size) 200218.

The payload section 17022 is configured from the encryption content.

Even if transmitting contents by utilizing for example an RTP protocol, contents configured the same as in FIG. 22 can be transferred by substituting the HTTP header 2001 with an RTP header. Alternatively, by storing both an RTP header and a content transfer packet 2002 into each RTP packet, copy controlled (or limited) information can be sent with a greater probability of success.

The present embodiment as described above is capable of safely utilizing contents by remote access by establishing a secure communication path between the out-of-home device and the in-home router 500, and exchanging content and control commands along that secure communication path. The out-of-home device can safely acquire information on devices connected to an in-home network, and also devices on the in-home network are capable of easily acquiring information on devices for access from outside the home.

### Second Embodiment

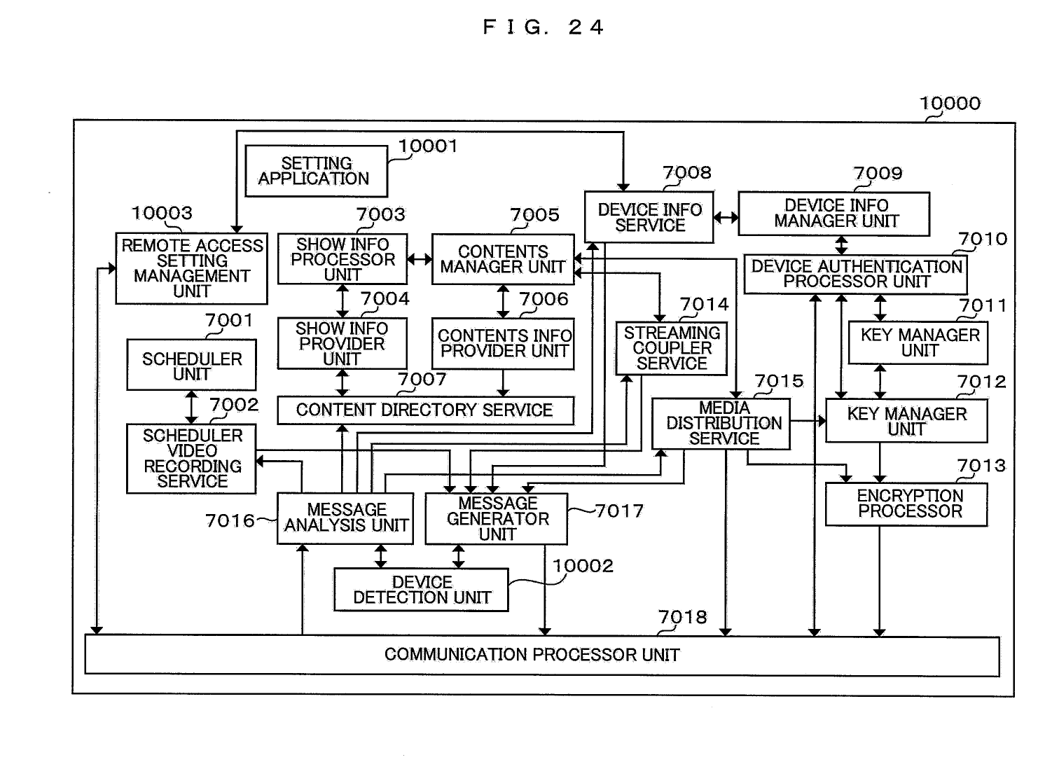

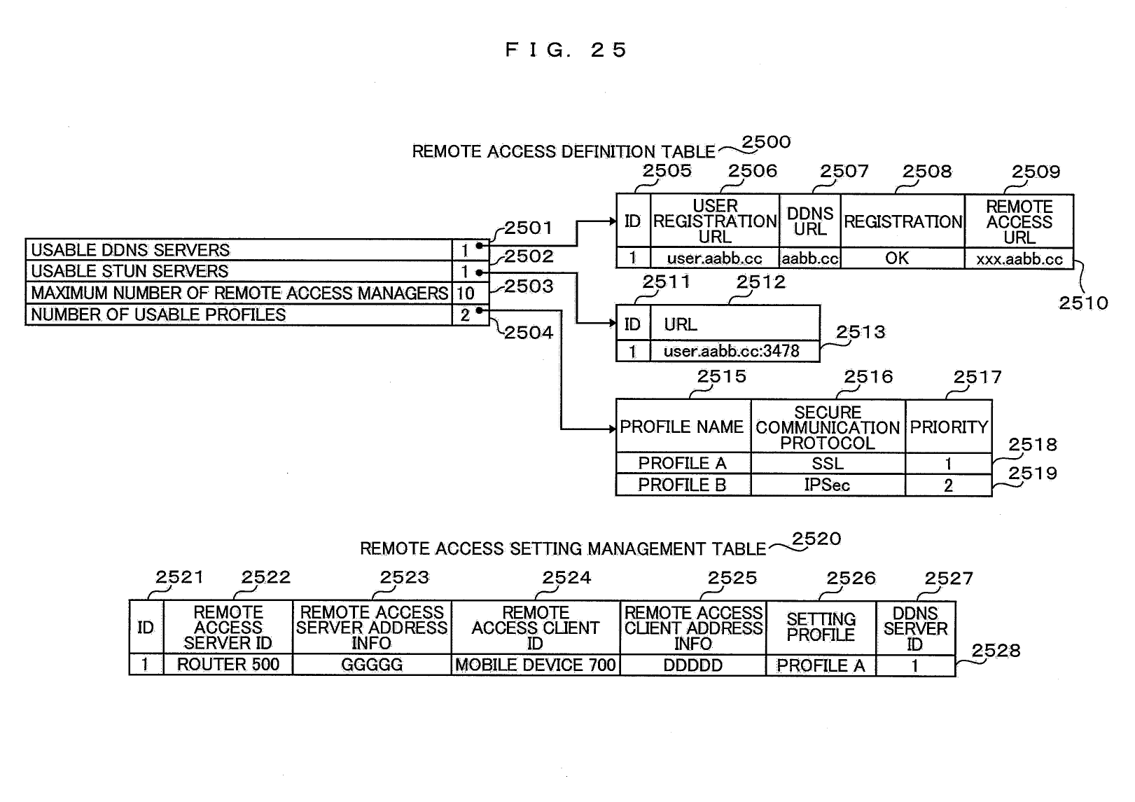

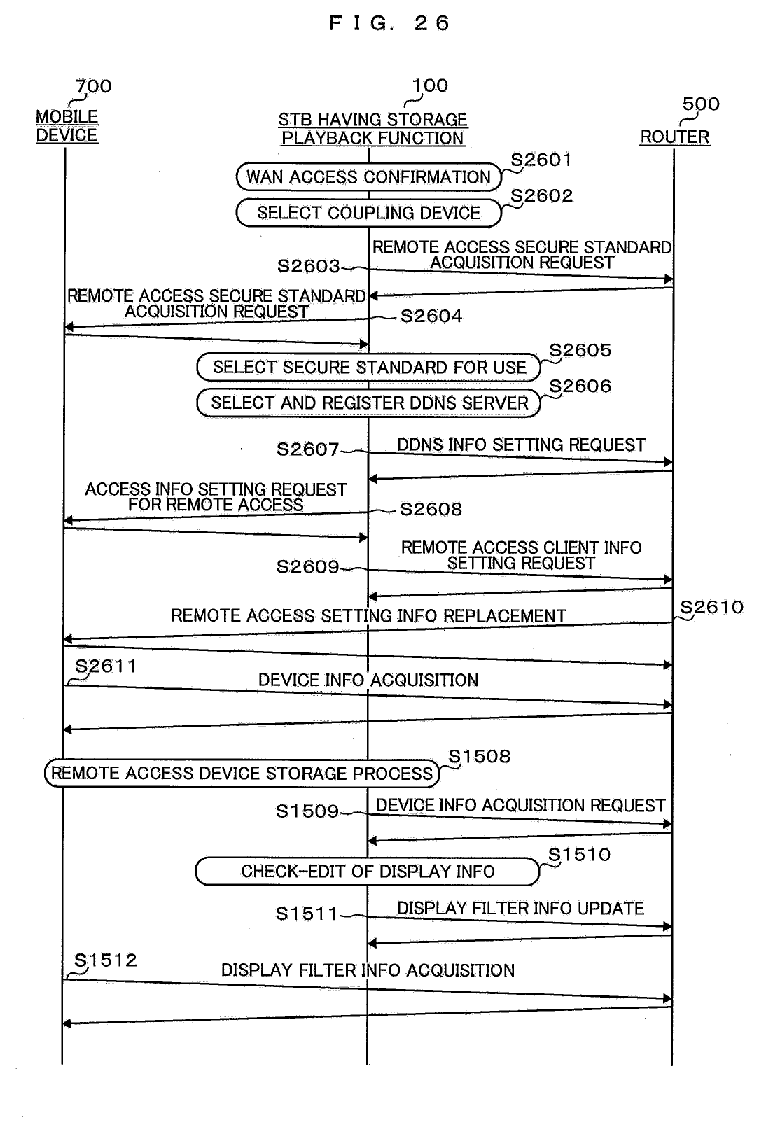

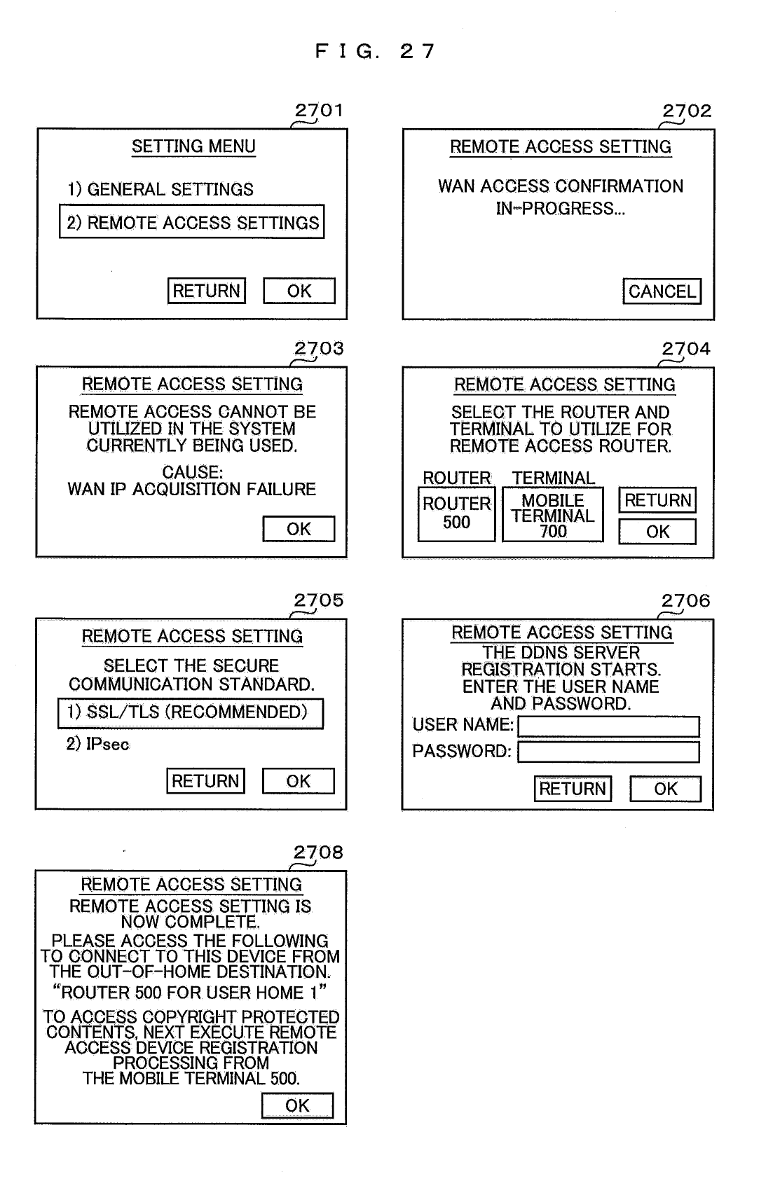

In the first embodiment, among the registration processing that must be implemented in advance for accessing the router 500 or the in-home device (such as the STB for storage and playback 100) from a device that is brought to outside the home (mobile device 700); an example is given showing setting of a secure communication method between the mobile device 700 and the router 500. In the present embodiment, the case where the setting of a secure communication method is implemented from the STB having storage playback function 100 is shown using FIG. 24, FIG. 25, FIG. 26 and FIG. 27.

FIG. 24 is a drawing showing a software configuration example in the present embodiment for the STB having storage playback function 100 shown in FIG. 3.

The control software 10000 for implementing functions of the STB having storage playback function 100 is executed by the control unit 111 in the memory 110 of the STB having storage playback function 100. FIG. 24 describes the control software 10000 divided into functional blocks, and each block can be divided or unified. Moreover the control software 10000 need not be implemented on one program and can even be implemented by a combination of two or more programs.

The setting application 10001 is an application that provides environmental settings required for implementing remote access between the router 500 and the mobile device 700 to the user. The setting application 10001 controls the device detection unit 10002 or remote access setting management unit 10003, and communication processor unit 7018 and performs communication settings.

The device detection unit 10002 detects notification of connection or detachment to a network of another device, and when connection with a device for control is detected, acquires that device information and information on the services provided for that device. The device detection unit 10002 also sends a device search request for searching for a desired device for control over a network as needed.

The remote access setting management unit 10003 utilizes technology such as a STUN client function based on the contents stored in the table of FIG. 25, to confirm the WAN IP of the router, and to confirm if a connection is possible from the home network or in other words from an external location to the router 500. The remote access setting management unit 10003 manages the utilizable DDNS information and gives instruction to the user during settings. The remote access setting management unit 10003 sets DDNS information to the remote access server unit of the router, information for secure method and the mobile device based on the user instructions, and sets a secure method for router information (router access URL) to the remote access client unit of the mobile device.

A configuration example of the remote access management information handled by the remote access setting management unit 10003 for the STB having storage playback function 100 is described while referring to FIG. 25. This management information is stored in the memory 110.

The remote access management information is comprised of a remote access definition table 2500, and a remote access setting management table 2520.

The remote access definition table 2500 is comprised of usable DDNS servers 2501, usable STUN servers 2502, maximum number of remote access managers 2503, and a number of usable profiles 2504.

The usable DDNS servers 2501 is a region holding information regarding the number of usable DDNS servers when remotely accessing the STB having storage playback function 100, and is set to a “1” for example. The supplier-operator for the STB having storage playback function 100 provides a DDNS server and setting information in this region in advance gives the advantage that the user need not search for DDNS server services separately in order to utilize the DDNS server. Also, the supplier-operator for the STB having storage playback function 100 can control the security policy during remote access by utilizing a secure DDNS service that it itself manages.

As DDNS server information, the remote access setting management unit 10003 for the STB having storage playback function 100 contains an ID 2502 as an identifier to uniquely identify DDNS server information within the STB having storage playback function 100; a server URL 2506 for use as the access destination when registering the user in the DDNS server; a DDNS URL 2507 as an access destination for notifying the DDNS server that the router 500 is changing the IP address; a registration 2508 showing whether or not registration for the DDNS server is finished; and a remote access URL 2509 for the mobile terminal 500 utilizing the DDNS server in order to access the router 500 in the user home 1 from an out-of-home destination and to access the STB having storage playback function 100 by way of the router 500; retained in a number equivalent to the number of utilizable DDNS servers. The present embodiment shows an example where a “1” is registered in the usable DDNS server 2501 so that a one case portion of the record 2510 is retained. The user ID and password may also be retained as DDNS server information in order to access the DDNS server.

The usable STUN server 2502 is a region for holding information relating to the STUN server and is utilized when the remote access setting management unit 10003 for the STB having storage playback function 100 checks WAN access by utilizing a STUN client function, and is set to “1” for example.

As STUN server information, the remote access setting management unit 10003 for the STB having storage playback function 100, retains the ID 2511 as an identifier for uniquely identifying STUN server information, and a URL 2512 as the access destination to access when checking WAN access; within the STB having storage playback function 100 in a number equivalent to the number of usable STUN servers 2502. The present embodiment shows an example where a “1” is registered in the usable DDNS server 2502 so that a one case portion of the record 2513 is retained.

The maximum number of remote access managers 2503 shows the maximum number of management for information relating to remote access client and remote access servers set by the remote access setting management unit 10003 for the STB having storage playback function 100, and is set to “10” for example.

The number of usable profiles 2504 shows the number of usable profiles for secure communication protocols (SSL, IPsec, VPN, etc.) that are utilized for establishing secure communication channels between devices (such as the router 500) having remote access server functions and devices (such as the mobile device 700) having remote access client functions for access from outside the home, in order to access the STB having storage playback function 100 from outside the home. The number of usable profiles 2504 is set to “2” for example. Here, devices having remote access client functions are for example, devices having the functions of the remote access client unit 8015 of the mobile device 500, the remote access discovery agent unit 8014, and the remote access transport agent unit 8016.

As usable profile information, the remote access setting management unit 10003 for the STB having storage playback function 100 contains a profile name 2515 as an identifier for uniquely identifying usable profile information in the STB having storage playback function 100; a secure communication protocol 2516 for showing the secure communication protocol, and a priority 2517 for showing the usage priority of the profile; in a number equivalent to the number of usable profiles 2504. The present embodiment shows an example where a “2” is registered in the number of usable profiles 2504 so that a two case portion of record 2518 and 2519 retained by recording. Here, the priority 2517 of the record 2158 (profile A) is a “1”, and the priority 2517 of the record 2159 (profile B) is a “2” so that the remote access setting management unit 10003 for the STB having storage playback function 100 instructs the user so as to utilize with profile A having priority or performs the setting itself.

Managing the profile information usable by the STB having storage playback function 100 in this way, provides the benefit that the supplier-operator for the STB having storage playback function 100 can implement the security level management such as prohibiting the remote access registration of the STB having storage playback function 100 when secure communication on a level required by the operator cannot be established between the router 500 and the mobile terminal 700.

The remote access setting management table 2520 is a table for managing the setting information relating to device combinations for devices containing remote access client functions and devices containing remote access server functions set by the STB having storage playback function 100. Each record 2528 of the remote access setting management table 2520 includes: an ID 2521 of the record, a remote access server ID 2522, a remote access server address info 2523, a remote access client ID 2524, a remote access client address info 2525, a setting profile 2526, and a DDNS server ID 2527.

The ID 2521 shows a registration number for the record in the remote access setting management table 2520.

The remote access server ID 2522 shows an identifier for identifying a device having a remote access server function.

The remote access server address info 2523 shows the IP address and MAC address for a device having a remote access server function.

The remote access client ID 2524 shows an identifier for identifying a device having a remote access client function.

The remote access client address info 2525 shows the IP address and MAC address for a device having a remote access client function.

The setting profile 2526 shows an identifier for profile information that is utilized when establishing a secure communication channel between the remote access server and the remote access client.

The DDNS server ID 2527 shows an identifier for the DDNS server that is utilized when a device having a remote access client function is accessing the STB having storage playback function 100 by way of a device having a remote access server function, and is set to any value registered in the ID 2505 serving as an identifier for DDNS server information.

In the present embodiment, an example of a device combination having a pair that is a device having a remote access client function and a device having a remote access server function are shown in the record 2528. Here, a “1” is set in ID 2521, an identifier for the router 500 is set in the remote access server ID 2522, address information for the router 500 is set in the remote access server address info 2523, an identifier for the mobile device 500 is set in the remote access client ID 2524, address information for the mobile device 500 is set in the remote access client address info 2525, a profile A is set in the setting profile 2526, and an identifier “1” for DDNS server information is set in the server ID 2527. These information show that when utilizing the STB having storage playback function 100 from outside the home by way of a mobile terminal 500, the remote access server function of the router 500 is utilized, and access by secure communication of profile A by utilizing a DDNS server having a “1” set in its DDNS server information ID.

The present embodiment shows an example utilizing a remote access setting management table 2520 for managing a combination of a device having a remote access client function and a device having a remote access server function; however the management can also be separated into a management table for a device having a remote access client function and a management table for a device having a remote access server function.

In the present embodiment, the user utilizes the remote control 17 and the monitor 400 to operate the screen provided by the STB having storage playback function 100 to register the remote access settings in the router 500 and the mobile device 700. The registration procedure for the setting is described next while referring to FIG. 26 and FIG. 27. Here, prior to starting this registration, the STB having storage playback function 100 acquires in advance, the address information for use by the local access communication processor unit 9008 of the router 500, and the name or the identifier for uniquely identifying the router 500, and the address information utilized by the communication processor unit 8017 of the mobile device 700, and the name or the identifier for uniquely identifying the mobile device 700. The STB having storage playback function 100 and the mobile device 700 are registered in advance in the in-home device info table 1410 for the router 500.

When the user operates the remote control 17 of the STB having storage playback function 100 to start the setting application 10001, the setting application 10001 for example displays the screen 2701 on the monitor 400. A “General Setting” menu for performing general settings on the STB having storage playback function 100, and a “Remote Access Setting” menu for remotely accessing the STB having storage playback function 100 from outside the home are displayed on the screen 2701.

When the user selects the “Remote Access Setting” menu on the screen 2701, the setting application 10001 requests the remote access setting management unit 10003 to execute the WAN access confirmation process S2601. The WAN access confirmation process S2601 is a process for checking whether or not access is possible from the Internet side to the user home 1 or in other words access is possible by way of the wireless access point 20 when the mobile device 700 is taken to outside the home. The setting application 10001 display for example the screen 2702 until the WAN access confirmation process S2601 processing is complete. In the WAN access confirmation process S2601, the remote access setting management unit 10003 for example utilizes the STUN client function, and utilizes the usable STUN server information retained in the remote access definition table 2500 of FIG. 25; acquires the WAN side IP address of the router 500 when accessing the Internet 13 from the user home 1 by way of the communication processor unit 7018, and checks whether access is possible with the user home 1 from outside the home. Decision criteria that are utilized for judging whether access to the user home 1 from outside the home is possible are for example, whether the WAN side IP address is a global IP address or not; and whether the WAN side IP address of the router 500 matches the WAN side IP address that is acquired using the STUN client function, etc.

When results from the WAN access confirmation S2601 is that access to the user home 1 from outside the home is not possible, the setting application 10001 shows for example an error display on the screen 2703 to the user to provide the information that remote access to the STB having storage playback function 100 is impossible in the user home 1 environment.

When deciding that results from the WAN access confirmation process S2601 is that access to the user home 1 from outside the home is possible, the setting application 10001 for the STB having storage playback function 100 acquires a list of devices having remote access server function by utilizing the device info service 7008 and devices having remote access client functions by utilizing the device info service 7008, from information for devices that is detected by the device detection unit 10002 and managed in the device info manager unit 7009, and displays this list for example on the screen 2704 (S2602). The user selects a device having one remote access server function and a device having one or plural remote access client functions from the displayed device list, and selects for what device to set remote access. In the example displayed on the screen 2704, the device having remote access server function is displayed as “Router” and the device having remote access client function is displayed as “Terminal”.

Here the example shows the case where the user selects the router 500 in “Router”, and selects for the mobile terminal 700 in “Terminal.” When the user selects the router 500 and the mobile terminal 700, the setting application 10001 notifies the remote access setting management unit 10003 of that fact, and the remote access setting management unit 10003 sends a “Remote access secure standard acquisition request” message to the router 500 by way of the communication processor unit 7018 for acquiring a protocol for the router 500 to establish a secure communication path with devices outside the home. The remote access server unit 9004 for the router 500 that acquires the “Remote access secure standard acquisition request” message, notifies the STB having storage playback function 100 of the support profile info 1407 registered in the device information by utilizing the coupler setting info management service 9006. When the remote access setting management unit 10003 for the STB having storage playback function 100 receives the support profile info 1407, it compares the support profile info 1407 with usable profile information that is held in the remote access definition table 2500, and confirms if there is a suitable match. When there is no suitable match, notification is given to the setting application 10001, the setting application 10001 decides that remote accessing of the user home 1 from outside the home is impossible and for example displays a “Cause: There is no match for the RAS recommended profile” message in the screen 2703 on the monitor 400, and instructs the user of the fact that remote access with the STB having storage playback function 100 is impossible in the user home 1 environment (S2603). The present embodiment only shows an exchange with the router 500 however the present processing can be executed among plural devices having remote access server function and can ultimately decide whether a remote access environment can be achieved with the user home 1 environment from outside the home, by whether or not there are devices having remote access function that matches a profile within the home.

When there is a suitable match in the profile information, the remote access setting management unit 10003 sends a “Remote access secure standard acquisition request” message by way of the communication processor unit 7018 in order for the mobile device 700 to acquire a protocol supporting the establishing of a secure communication path with the device having a remote access server function. The remote access client unit 8015 for the mobile device 700 that acquires the “Remote access secure standard acquisition request” message utilizes the coupling setting info processing unit 8018 to notify the STB having storage playback function 100 of the support profile information 1103 that is registered in the device information. When the remote access setting management unit 10003 for the STB having storage playback function 100 receives the support profile information 1103, the remote access setting management unit 10003 compares it with the usable profile information held in the remote access definition table 2500 to check whether there is a match. When there is no match, the remote access setting management unit 10003 notifies the setting application 10001 of this fact, and the setting application 10001 decides that an environment capable of supporting remote access with the user home 1 from outside the home is impossible, and displays a screen set with the “Cause: There is no match for the RAC recommended profile” message in the screen 2703 on the monitor 400 to instruct the user that remote accessing of the STB having storage playback function 100 is impossible in the user home 1 environment (2604). The present embodiment only shows an exchange with the mobile terminal 700 however the present processing can be executed among plural devices having a remote access client function and can ultimately decide whether or not a remote access environment can be achieved with the user home 1 environment from outside the home, by whether or not there are devices having a remote access client function that matches a profile within the home.

The list of devices that is displayed in screen 2704 need not display all devices having remote access server function, and all devices having remote access client function, but does execute a remote access secure standard acquisition request (S2603 and S2604) in advance for all devices and only displays those with a matching profile. By displaying only the matching profiles, the wasted operation occurring from displaying the error after selecting a device with a nonmatching profile by the user can be avoided.

When there is more than one method matching both the support profile information 1103 of mobile device 700 and the support profile information 1407 of the router 500, the setting application 10001 for the STB having storage playback function 100 displays for example a screen 2705 on the monitor 400 that urges the user to select a secure communication method for use, and accepts the secure communication method selection. Here, besides accepting the selection of a secure communication method by the user, the setting application 10001 or the remote access setting management unit 10003 may also automatically select a secure communication method based on the priority 2517 registered in the usable profile information of the remote access definition table 2500 or another optional method (for example, a previously registered communication method, a high usage frequency and high security level, installed with the latest software, etc.) (S2605).

When the secure communication method is decided, the remote access setting management unit 10003 checks whether there is an “OK” in the Registration 2508 among the DDNS server information registered in the usable DDNS server information of the remote access definition table 2500. When there is an already registered item, the remote access setting management unit 10003 sends a “DDNS information setting request” message including that DDNS server information to the router 500. The remote access server unit 9004 for the router 500 that receives the “DDNS information setting request” message registers the DDNS server information in the registration information 1408. A reply is then sent back to the STB having storage playback function 100 on whether the setting is completed or not (S2607). When there is no already registered DDNS server, the setting application 10001 display for example a screen 2706 on the monitor 400 to urge the user to register one of the DDNS servers, and executes registration processing for the DDNS information (S2606). The process 2607 is implemented after user registration of the DDNS server.

The remote access setting management unit 10003 for the STB having storage playback function 100 that receives the setting results from the “DDNS information setting request” sends a “Remote access information setting request” message containing information on the STB having storage playback function 100, information on the router 500 that is utilized in the remote accessing, and the secure communication method that is decided in S2604, to the mobile device 700. The remote access client unit 8015 for the mobile device 700 that receives the “Remote access information setting request” message utilizes the coupling setting info manager unit 8018 to register information relating to the STB having storage playback function 100 and information relating to the router 500 in the device info table 1110, and the remote access client unit 8015 sends back information to the STB having storage playback function 100 about whether the information is set or not (S2608). When the remote access client unit 8015 sets information relating to the router 500, the profile used 1124 registers a profile expressing the secure communication method set in S2604, and registers DDNS server information that executes the setting request to the server 500 in S2608 in the DDNS server information. An identifier expressing the router 500 is registered in the router information 1134 when setting information relating to the STB having storage playback function 100. The example shown here described appending at one time, the secure communication method and information for the STB having storage playback function 100 as the “Remote access information setting request” however this information may be sent to the mobile device 700 a plural number of times divided into separate requests.

The remote access setting management unit 10003 for the STB having storage playback function 100 that receives the setting results from the “Remote access client information setting request” sends a “Remote access client information setting request” message containing the secure communication method set in S2604, information on the mobile device 700 for performing the remote accessing, and information on the DDNS server for use to the router 500. The remote access server unit 9004 for the router 500 that receives the message, registers the information 1458 relating to the mobile device 700 in the out-of-home device info table 1440 by using the coupler setting info management service 9006, sets the device ID 1452 and the profile name of the secure communication method contained in this message to the Profile used 1456, and set the information on the DDNS server for use in the DDNS used (DDNS server for use) 1457. The remote access server unit 9004 then sends back a reply about whether the setting is made or not to the STB having storage playback function 100 (S2609). The example shown here described appending at one time, the secure communication method, information on the mobile device 700 for performing the remote accessing, and information for the DDNS server for use as the “Remote access client information setting request”, however this information may be sent to the router 500 a plural number of times divided into separate requests.

The remote access setting management unit 10003 for the STB having storage playback function 100 that checks the setting of the remote access information for both the router 500 and the mobile device 700 by the processing in S2608 and the processing in S2609, notifies the setting application 10001 of this fact, the setting application 10001 displays for example a screen 2708 on the monitor 400, and urges the user to shift to the next setting operation. The screen 2708 shows the example when executing the remote access device registration processing S1508 is required to set for accessing copyright-protected contents from outside the home by an operation from the mobile device 700.

However, the remote access server unit 9004 for the router 500 that sends back the “Remote access client information setting request” result, sends a “Remote access setting info replacement” message including information on the router 500 itself that is utilized when establishing a secure communication channel in the mobile device 700 and router 500, to the mobile device 700. The remote access client unit 8015 for the mobile device 700 that receives the “Remote access setting info replacement” message, holds the received information in the profile used 1124 of the device info table 1110, and afterwards sends back a reply including information on the mobile device 700 itself that is utilized when establishing a secure communication channel in the router 500 and mobile device 700, to the router 500. The remote access server unit 9004 for the router 500 that receives the reply, retains the received information in the profile used 1456 in the record 1458 of the out-of-home device info table 1440 (S2610).

Next, the setting application 8020 for the mobile device 700 urged to start processing by way of the operating IF unit of the mobile terminal 700, from operation by the user who was urged by the display on the screen 2708 to start the remote access device registration processing by mobile terminal 700 operation; sends a “Device info relating to the in-home network acquisition” message to the router 500 in order to acquire information relating to devices permitted a remote access function in devices on the in-home network. The remote access server unit 9004 for the router 500 that receives the “Device info relating to the in-home network acquisition” message, utilizes the filter setting service 9005 to extract device information whose setting value for the out-of-home release 1426 is “Valid” from the device information registered in the in-home device info table 1410, to send back those extracted contents to the mobile device 700 (S2611).

Hereafter, a description of the processing where the assigned numbers are the same as in FIG. 15 described in the first embodiment is omitted since this processing is identical to those for the previously described content.

By the above registration processing, the user is capable of executing the registration necessary for accessing the contents in the STB having storage playback function 100 from a mobile device 700 brought to outside the home by utilizing the setting application 10001 for the STB having storage playback function 100.

Here, the above described sequence of S2603 through S2605, and S2606 through 2607 may also be executed in reverse.

In S2610, the “Remote access setting info replacement” message is sent from the router 500, conversely however the “Remote access setting info replacement” message may also be sent from the mobile device 700.

In S2611, the setting application 8020 for the mobile device 700 sends the “Device info relating to the in-home network acquisition” message however, may display the device searched or detected by the setting application 8020 itself on the screen 1802, and may also send a “Device info relating to the in-home network acquisition” message instead of the “Display filter information acquisition” message of S1512 or to either before or after the message of S1512.

The remote access server unit 9004 for the STB having storage playback function 100 may execute S1510 and S1511 without sending the “Device information acquisition request” message in S1509.

The remote access device registration process S1508 may execute the processing from prior to S1501, or may even execute the processing from after S1501. In that case, the S1509 through S1511 processing executed by the remote access server unit 9004 for the STB having storage playback function 100 can also be executed in parallel with the S2601 through S2611 that is executed by the setting application 10001 for the STB having storage playback function 100.

In the present embodiment, when setting a secure method for remote accessing from the STB having storage playback function 100, and the secure setting cannot satisfy the standards requested by the content providers such as the cable television operators who provides the STB having storage playback function 100 between the in-home network and out-of-home network; or when the required conditions cannot be satisfied for copyright-protection or parental protection for the device accessing the STB having storage playback function 100 from an out-of-home network, and also when conditions required by the content providers such as the cable television operators that supplies the STB having storage playback function 100 cannot be satisfied; restrictions can be established such as discontinuing the remote access setting or not distributing contents that the STB having storage playback function 100 or namely the content provider provides to outside the home.

The present invention is not limited the above embodiment and may include all manner of adaptations and variations. The above embodiments for example are described in detail to make the present invention easy to understand however the present invention need not always include all of the described configurations. Moreover, a portion of the configuration in an embodiment can be substituted into the configuration of another embodiment, and the configuration of another embodiment can be added to the configuration of an embodiment. Other configurations can be added, deleted, or substituted into a portion of the structure of each embodiment.

Each of the above configurations, functions, process units, and processing methods may be implemented in whole or in part by hardware such an integrated circuit design. Also needless to say, a program may interpret and execute each of the respective functions or configurations by way of a processor. Information such the programs, tables, or files for implementing each function may be placed on a recording device such as a memory, a hard disk, and SSD (Solid State Drive) or a recording medium such as an IC card, SD card, and DVD, etc.

Also, the control lines and information lines shown are considered necessary for the description but might not always show all of the control lines and information lines required for a product. All of the configurations may in fact be considered to be mutually connected.

### DESCRIPTION OF SIGNS

1 USER HOME
3,4 CONTENT PROVIDER (BROADCAST STATION)
7 DDNS SERVICE SERVER
5,6 COMMUNICATION SERVICE PROVIDER
21,22 CONTENT PROVIDER (IP DISTRIBUTION PROVIDER)
100 STB HAVING STORAGE PLAYBACK FUNCTION
200 TV HAVING STORAGE PLAYBACK FUNCTION
300 STB
400 MONITOR
500 ROUTER
700 MOBILE DEVICE
8019 CONTENTS VIEWING APPLICATION
8020 SETTING APPLICATION
8004 CONTENT DIRECTORY CONTROLLER
8007 MEDIA RECEIVING CONTROLLER
8008 DEVICE INFO SERVICE
8009 DEVICE INFO MANAGER UNIT
8010 DEVICE AUTHENTICATOR PROCESSOR UNIT
8012 KEY GENERATOR UNIT
8013 DECRYPTION PROCESSOR
8014 REMOTE ACCESS DISCOVERY AGENT UNIT
8015 REMOTE ACCESS CLIENT UNIT
8018 COUPLING SETTING INFO MANAGER UNIT
8016 REMOTE ACCESS TRANSPORT AGENT UNIT
9001 REMOTE ACCESS DISCOVERY AGENT UNIT
9002 DEVICE INFO SERVICE
9003 REMOTE ACCESS TRANSPORT AGENT UNIT
9004 REMOTE ACCESS SERVER UNIT
9005 FILTER SETTING SERVICE
9006 COUPLER SETTING INFO MANAGEMENT SERVICE
10003 REMOTE ACCESS SETTING MANAGEMENT UNIT

1. A content transmission device coupled to an in-home network, and comprising:
a device information manager unit that registers and manages the device information received from a content-receiving device and a relay device;
a content provider unit that provides the contents to the content-receiving device; and
a remote access setting management unit that performs settings to send the contents to the content-receiving device coupled to the content transmission device by way of an out-of-home network based on the device information that is registered and managed in the device information manager unit,
wherein, the remote access setting management unit:
sets a first coupling information to couple the in-home network and the out-of-home network by a secure communication path, to a relay device containing a remote access server function that relays the in-home network and the out-of-home network communications;
sets a second coupling information to couple by the secure communication path to the content-receiving device containing a remote access client function that acquires the contents and data from the content transmission device coupled to the out-of-home network; and
the content provider unit provides the content by way of the secure communication path when providing the contents to the content-receiving device coupled from the out-of-home network.

2. The content transmission device according to claim 1,
wherein the remote access setting management unit:
manages a third coupling information to couple the in-home network and the out-of-home network by the secure communication path,
sets the first or the second coupling information based on the device information managed by the device information management method in the relay device or the content-receiving device, when the device information for the content-receiving device or the relay device managed by the device information manager unit is adaptable to the third coupling information; and
when not adaptable, the first or the second coupling information is not set in the relay device or the content-receiving device.

3. The content transmission device according to claim 1,
wherein the remote access setting management unit:
manages information for the external server coupled to an out-of-home network; and
decides whether or not the out-of-home network can be coupled by way of the in-home network based on information acquired from the external server.

4. The content transmission device according to claim
wherein the remote access setting management unit manages information for the DDNS server required for coupling to the in-home network from the out-of-home network.

5. The content transmission device according to claim 1,
wherein the device information that the device information manager unit records and manages, includes information on devices including the remote access server function and devices including the remote access client function.
